(19) United States
(12) Patent Application Publication
(10) Pub. No.: US 2017/0089039 A1
(43) Pub. Date: Mar. 30, 2017

(54) ENGINE CONTROL DEVICE OF HYBRID WORK MACHINE, HYBRID WORK MACHINE, AND ENGINE CONTROL METHOD OF HYBRID WORK MACHINE

(71) Applicant: Komatsu Ltd., Tokyo (JP)

(72) Inventors: Tomotaka Imai, Hiratsuka-shi (JP); Tsubasa Ohira, Hiratsuka-shi (JP); Masaru Shizume, Yokohama-shi (JP); Tadashi Kawaguchi, Hiratsuka-shi (JP)

(21) Appl. No.: 14/906,380

(22) PCT Filed: Sep. 30, 2015
(86) PCT No.: PCT/JP2015/077712

§ 371 Date: Jan. 20, 2016

(51) Int. Cl. E02F 9/20; F04B 1/14; B60W 20/15; B60W 10/08; B60W 10/06; F04B 1/29; F04B 51/00

(52) U.S. Cl. CPC E02F 9/2075; F04B 1/295; F04B 1/146; F04B 51/00; B60W 10/08; B60W 10/06; B60W 20/15; B60K 6/485

(57) ABSTRACT

In controlling an engine generating motive power of which an output shaft extracting the generated motive power is connected to a generator motor, an engine control device causes the generator motor to generate motive power when both of a first condition satisfied based on a comparison of an actual revolution speed of the engine with a revolution speed acquired from first and second relationships and a second condition satisfied based on a comparison of a torque of the engine at the actual revolution speed with a torque acquired using the first relationship at the actual revolution speed are satisfied. The first relationship is between the revolution speed of the engine and the torque generated by the engine at the revolution speed, and the second relationship is between the torque and the revolution speed of the engine and defines a magnitude of the motive power generated from the engine.

### FIELD

The present invention relates to a technique of controlling an engine of a hybrid work machine.

### BACKGROUND

A work machine includes, for example, an internal combustion engine as a power source that generates motive power for traveling or motive power for operating a working implement. Recently, for example, as described in Patent Literature 1, a work machine is known in which an internal combustion engine and a generator motor are combined to use motive power generated by the internal combustion engine as motive power of a working implement and to generate electric power by driving the generator motor with the internal combustion engine.

### CITATION LIST

### Patent Literature

Patent Literature 1: Unexamined Japanese Patent Application Publication No. 2012-241585

### SUMMARY

### Technical Problem

When a load acting on an internal combustion engine temporarily increases, there is a possibility that the revolution speed of the internal combustion engine will greatly decrease or the internal combustion engine will stop (engine stop).

An object of the present invention is to suppress a great decrease in revolution speed of an internal combustion engine when a load of the internal combustion engine temporarily increases.

### Solution to Problem

According to the present invention, an engine control device of a hybrid work machine comprising, in controlling an internal combustion engine which is an engine generating motive power and of which an output shaft used to extract the generated motive power is connected to a generator motor, causing the generator motor to generate motive power when both of a first condition which is satisfied or not satisfied based on a result of comparison of an actual revolution speed of the internal combustion engine with a revolution speed acquired from a first relationship and a second relationship and a second condition which is satisfied or not satisfied based on a result of comparison of a torque of the internal combustion engine at the actual revolution speed with a torque acquired using the first relationship at the actual revolution speed are satisfied, wherein the first relationship is a relationship between a revolution speed of the internal combustion engine and a torque which is able to be generated by the internal combustion engine at the revolution speed, and wherein the second relationship is a relationship between the torque and the revolution speed of the internal combustion engine which is used to define a magnitude of the motive power generated from the internal combustion engine.

In the present invention, it is preferable that wherein the first condition is satisfied when the actual revolution speed of the internal combustion engine is equal to or lower than the revolution speed acquired from the first relationship and the second relationship, and wherein the second condition is satisfied when the torque of the internal combustion engine at the actual revolution speed is equal to or greater than a value which is smaller by a predetermined magnitude than the torque acquired from the first relationship at the actual revolution speed.

In the present invention, it is preferable that wherein the engine control device determines the torque which is generated by the generator motor based on the torque acquired from the second relationship at the actual revolution speed and the torque acquired from the first relationship at the actual revolution speed.

In the present invention, it is preferable that wherein the engine control device increases a command value for causing the generator motor to generate electric power from a value smaller than a target value of the command value with a lapse of time when the engine control device switches from a state in which the generator motor generates motive power to a state in which the generator motor generates electric power.

In the present invention, it is preferable that wherein the engine control device causes the generator motor to generate motive power when the actual revolution speed of the internal combustion engine is equal to or lower than a revolution speed corresponding to a maximum torque of the first relationship.

According to the present invention, a hybrid work machine comprises: the engine control device of a hybrid work machine; the internal combustion engine; the generator motor that is driven by the internal combustion engine; and an electric power storage device that stores the electric power generated by the generator motor.

According to the present invention, an engine control method of a hybrid work machine comprising, in controlling an internal combustion engine which is an engine generating motive power and of which an output shaft used to extract the generated motive power is connected to a generator motor, determining whether to satisfy a first condition which is satisfied or not satisfied based on a result of comparison of an actual revolution speed of the internal combustion engine with a revolution speed acquired from a first relationship and a second relationship and a second condition which is satisfied or not satisfied based on a result of comparison of a torque of the internal combustion engine at the actual revolution speed with a torque acquired using the first relationship at the actual revolution speed; and outputting a drive command for driving the generator motor when both the first condition and the second condition are satisfied, wherein the first relationship is a relationship between the revolution speed of the internal combustion engine and the torque which is able to be generated by the internal combustion engine at the revolution speed, and wherein the second relationship is a relationship between the torque and the revolution speed of the internal combustion engine which is used to define a magnitude of the motive power generated from the internal combustion engine.

In the present invention, it is preferable that wherein the first condition is satisfied when the actual revolution speed of the internal combustion engine is equal to or lower than the revolution speed acquired from the first relationship as a relationship between the revolution speed of the internal combustion engine and the torque which is able to be generated by the internal combustion engine at the revolution speed and the second relationship as a relationship between the torque and the revolution speed of the internal combustion engine which is used to define the magnitude of the motive power generated from the internal combustion engine, and wherein the second condition is satisfied when the torque of the internal combustion engine at the actual revolution speed is equal to or greater than a value which is smaller by a predetermined magnitude than the torque acquired from the first relationship at the actual revolution speed.

### Advantageous Effects of Invention

According to the present invention, it is possible to suppress a great decrease in revolution speed of an internal combustion engine when a load of the internal combustion engine temporarily increases.

### BRIEF DESCRIPTION OF DRAWINGS

FIG. 1 is a perspective view illustrating an excavator which is a work machine according to an embodiment.

FIG. 2 is a diagram schematically illustrating a drive system of the excavator according to the embodiment.

FIG. 3 is a diagram illustrating an example of a torque diagram which is used to control an engine according to the embodiment.

FIG. 4 is a diagram illustrating an operational state of an internal combustion engine.

FIG. 5 is a diagram illustrating a state in which a load of the internal combustion engine increases.

FIG. 6 is a diagram illustrating control by an engine control device according to the embodiment.

FIG. 7 is a diagram illustrating the control by the engine control device according to the embodiment.

FIG. 8 is a diagram illustrating the control by the engine control device according to the embodiment.

FIG. 9 is a diagram illustrating an operation of an engine when a first condition is not satisfied and a generator motor generates electric power.

FIG. 10 is a diagram illustrating a variation example of a torque with respect to time when the generator motor generates electric power.

FIG. 11 is a diagram illustrating an operation of the engine when the first condition is not satisfied and the generator motor generates electric power in engine control according to the embodiment.

FIG. 12 is a diagram illustrating a modification of an output instruction line according to the embodiment.

FIG. 13 is a diagram illustrating a configuration example of a hybrid controller which performs the engine control according to the embodiment.

FIG. 14 is a control block diagram of the hybrid controller which performs the engine control according to the embodiment.

FIG. 15 is a control block diagram of the hybrid controller which performs the engine control according to the embodiment.

FIG. 16 is a control block diagram of the hybrid controller which performs the engine control according to the embodiment.

FIG. 17 is a control block diagram of the hybrid controller which performs the engine control according to the embodiment.

FIG. 18 is a control block diagram of the hybrid controller which performs the engine control according to the embodiment.

FIG. 19 is a control block diagram of the hybrid controller which performs the engine control according to the embodiment.

FIG. 20 is a control block diagram of the hybrid controller which performs the engine control according to the embodiment.

FIG. 21 is a flowchart illustrating an example of an engine control method according to the embodiment.

### DESCRIPTION OF EMBODIMENTS

A mode (embodiment) for carrying out the present invention will be described below in detail with reference to the accompanying drawings.

<Entire Configuration of Work Machine>

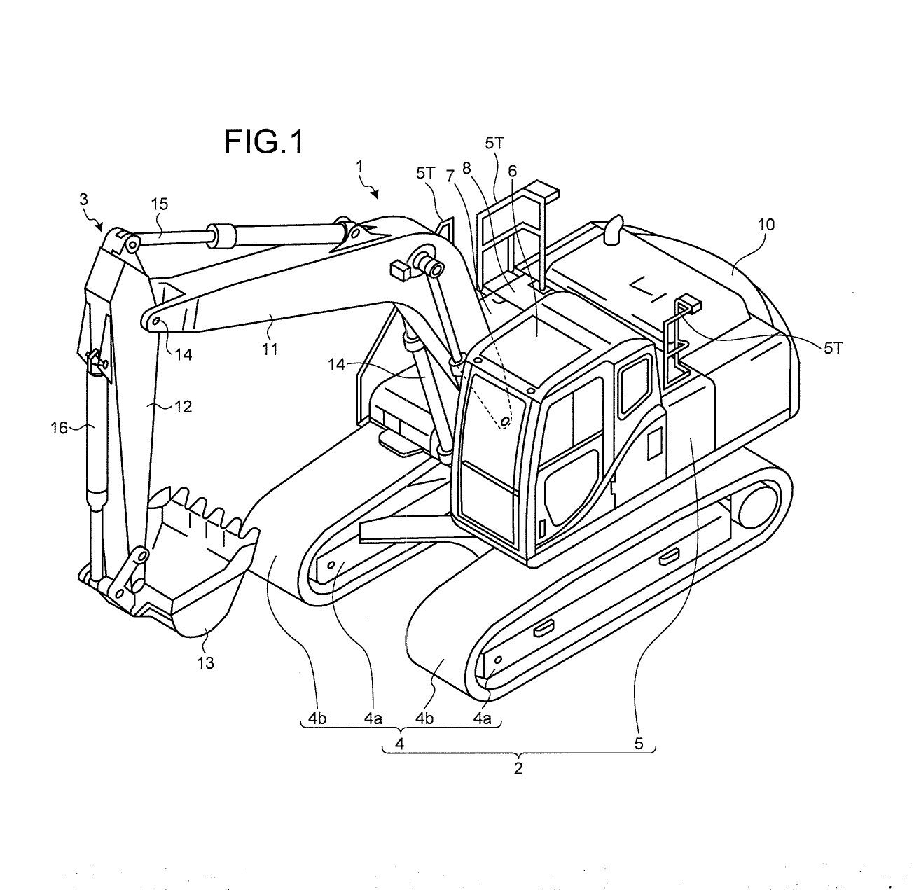

FIG. 1 is a perspective view illustrating an excavator 1 which is a work machine according to an embodiment. The excavator 1 includes a vehicle body 2 and a working implement 3. The vehicle body 2 includes a lower travel body 4 and an upper swing body 5. The lower travel body 4 includes a pair of travel mechanisms 4a and 4a. The travel mechanisms 4a and 4a include crawler belts 4b and 4b, respectively. Each of the travel mechanisms 4a and 4a includes a drive motor 21. The drive motor 21 illustrated in FIG. 1 drives the left crawler belt 4b. Although not illustrated in FIG. 1, the excavator 1 also includes a drive motor that drives the right crawler belt 4b. The drive motor that drives the left crawler belt 4b is referred to as a left drive motor and the drive motor that drives the right crawler belt 4b is referred to as a right drive motor. The right drive motor and the left drive motor cause the excavator 1 to travel or swing by driving the crawler belts 4b and 4b.

The upper swing body 5 is disposed on the lower travel body 4 so as to be swingable. The excavator 1 swings by a swing motor for causing the upper swing body 5 to swing. The swing motor may be an electric motor that converts electric power into a rotational force, may be a hydraulic motor that converts a pressure of a hydraulic fluid (a hydraulic pressure) into a rotational force, or may be a combination of the hydraulic motor and the electric motor. In this embodiment, the swing motor is an electric motor.

The upper swing body 5 includes a driver cabin 6. The upper swing body 5 includes a fuel tank 7, a hydraulic fluid tank 8, an engine room 9, and a counterweight 10. The fuel tank 7 contains fuel for driving an engine. The hydraulic fluid tank 8 contains a hydraulic fluid that is ejected to hydraulic cylinders such as a boom cylinder 14, an arm cylinder 15, and a bucket cylinder 16 and hydraulic devices such as the drive motor 21 from a hydraulic pump. The engine room 9 receives an engine serving as a power source of the excavator and devices such as the hydraulic pump supplying hydraulic fluid to the hydraulic devices. The counterweight 10 is disposed in the back of the engine room 9. A guard rail 5T is mounted on the top of the upper swing body 5.

The working implement 3 is mounted at the front center position of the upper swing body 5. The working implement 3 includes a boom 11, an arm 12, a bucket 13, the boom cylinder 14, the arm cylinder 15, and the bucket cylinder 16. The base of the boom 11 is coupled to the upper swing body 5 with a pin. By employing this structure, the boom 11 rotationally moves relative to the upper swing body 5.

The boom 11 is coupled to the arm 12 with a pin. Specifically, the tip of the boom 11 and the base of the arm 12 are coupled to each other with a pin. The tip of the arm 12 and the bucket 13 are coupled to each other with a pin. By employing this structure, the arm 12 rotationally moves relative to the boom 11. The bucket 13 rotationally moves relative to the arm 12.

The boom cylinder 14, the arm cylinder 15, and the bucket cylinder 16 are hydraulic cylinders which are driven by the hydraulic fluid ejected from the hydraulic pump. The boom cylinder 14 causes the boom 11 to move. The arm cylinder 15 causes the arm 12 to move. The bucket cylinder 16 causes the bucket 13 to move.

<Drive System 1PS of Excavator 1>

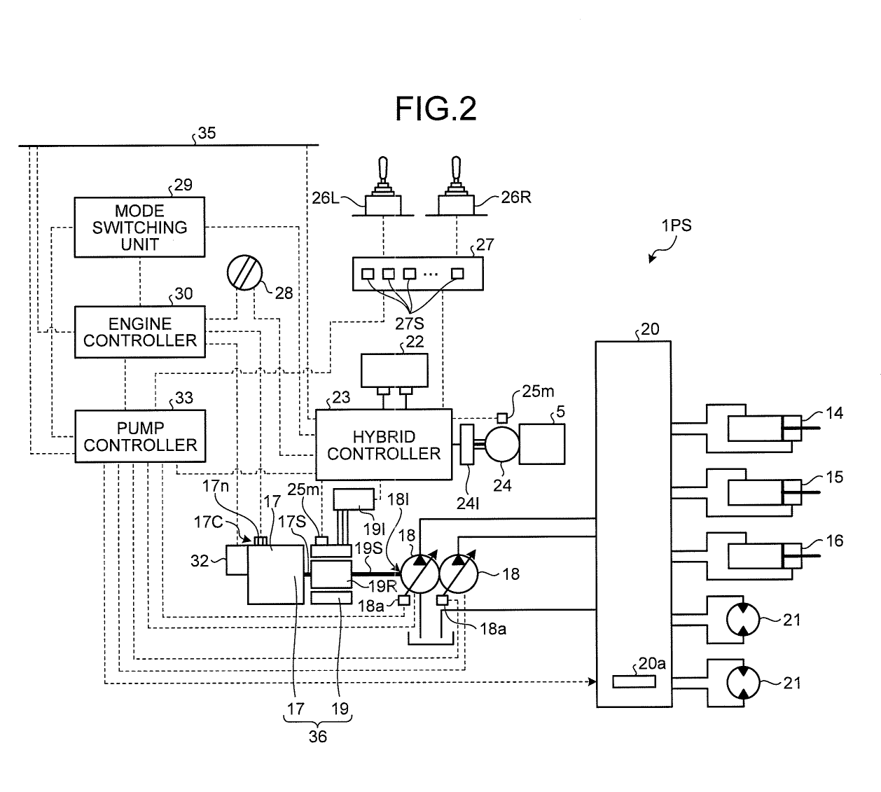

FIG. 2 is a diagram schematically illustrating a drive system of the excavator 1 according to the embodiment. In this embodiment, the excavator 1 is a hybrid work machine in which an internal combustion engine 17, a generator motor 19 that is driven to generate electric power by the internal combustion engine 17, an electric power storage device 22 that stores electric power, and an electric motor that is driven by the supply of electric power generated from the generator motor 19 or electric power discharged from the electric power storage device 22 are combined. Specifically, the excavator 1 causes the upper swing body 5 to swing with an electric motor 24 (hereinafter, appropriately referred to as a swing motor 24).

The excavator 1 includes the internal combustion engine 17, a hydraulic pump 18, the generator motor 19, and the swing motor 24. The internal combustion engine 17 is a power source of the excavator 1. In this embodiment, the internal combustion engine 17 is a diesel engine. The generator motor 19 is connected to an output shaft 17S of the internal combustion engine 17. By employing this structure, the generator motor 19 is driven to generate electric power by the internal combustion engine 17. When the motive power generated from the internal combustion engine 17 is insufficient, the generator motor 19 is driven to assist the internal combustion engine 17 by electric power supplied from the electric power storage device 22.

In this embodiment, the internal combustion engine 17 is a diesel engine, but is not limited to the diesel engine. The generator motor 19 is, for example, a switched reluctance (SR) motor, but is not limited to the SR motor. In this embodiment, a rotor 19R of the generator motor 19 is directly connected to the output shaft 17S of the internal combustion engine 17, but is not limited to this structure. For example, the rotor 19R of the generator motor 19 and the output shaft 17S of the internal combustion engine 17 may be connected to each other via a power take-off (PTO). The rotor 19R of the generator motor 19 may be connected to a transmission means such as a reduction gear connected to the output shaft 17S of the internal combustion engine 17 and may be driven by the internal combustion engine 17. In this embodiment, a combination of the internal combustion engine 17 and the generator motor 19 serves as a power source of the excavator 1. The combination of the internal combustion engine 17 and the generator motor 19 is appropriately referred to as an engine 36. The engine 36 is a hybrid-type engine in which the internal combustion engine 17 and the generator motor 19 are combined to generate motive power required for the excavator 1 as a work machine.

The hydraulic pump 18 supplies a hydraulic fluid to the hydraulic devices. In this embodiment, a variable displacement hydraulic pump such as a swash plate type hydraulic pump is used as the hydraulic pump 18. An input portion 181 of the hydraulic pump 18 is connected to a power transmission shaft 19S connected to the rotor of the generator motor 19. By employing this structure, the hydraulic pump 18 is driven by the internal combustion engine 17.

The drive system 1PS includes the electric power storage device 22 and a swing motor control device 241 as an electrical drive system for driving the swing motor 24. In this embodiment, the electric power storage device 22 is a capacitor, more specifically, an electric double layer capacitor, but is not limited to the capacitor. The electric power storage device 22 may be a secondary battery such as a nickel-hydrogen storage battery, a lithium ion battery, and a lead storage battery. The swing motor control device 241 is, for example, an inverter.

The electric power generated from the generator motor 19 or the electric power discharged from the electric power storage device 22 is supplied to the swing motor 24 via a power cable to cause the upper swing body 5 illustrated in FIG. 1 to swing. That is, the swing motor 24 causes the upper swing body 5 to swing by performing a powering operation with the electric power supplied (generated) from the generator motor 19 or the electric power supplied (discharged) from the electric power storage device 22. The swing motor 24 supplies (charges) the electric power storage device 22 with electric power by performing a regenerative operation when the upper swing body 5 decelerates. The generator motor 19 supplies (charges) the electric power storage device 22 with the electric power generated from itself. That is, the electric power storage device 22 may be charged with the electric power generated from the generator motor 19.

The generator motor 19 is driven to generate electric power by the internal combustion engine 17 or is driven to drive the internal combustion engine 17 by the electric power supplied from the electric power storage device 22. A hybrid controller 23 controls the generator motor 19 via a generator motor control device 19I. That is, the hybrid controller 23 generates a control signal for driving the generator motor 19 and supplies the control signal to the generator motor control device 19I. The generator motor control device 19I causes the generator motor 19 to generate electric power based on the control signal (regeneration) or causes the generator motor 19 to generate motive power (powering). The generator motor control device 19I is, for example, an inverter.

The generator motor 19 is provided with a revolution sensor 25m. The revolution sensor 25m detects a revolution speed of the generator motor 19, that is, the number of revolutions per unit time of the rotor 19R. The revolution sensor 25m converts the detected revolution speed into an electrical signal and outputs the electrical signal to the hybrid controller 23. The hybrid controller 23 acquires the revolution speed of the generator motor 19 detected by the revolution sensor 25m and uses the acquired revolution speed to control operational states of the generator motor 19 and the internal combustion engine 17. For example, a resolver or a rotary encoder is used as the revolution sensor 25m. In this embodiment, the revolution speed of the generator motor 19 detected by the revolution sensor 25m is equal to the revolution speed of the internal combustion engine 17. When the PTO or the like is interposed therebetween, the revolution speed has a predetermined ratio depending on a gear ratio or the like. In this embodiment, the revolution sensor 25m may detect the number of revolutions of the rotor 19R of the generator motor 19 and the hybrid controller 23 may convert the number of revolutions into a revolution speed. In this embodiment, the revolution speed of the generator motor 19 can be replaced with a value detected by a revolution speed sensor 17n of the internal combustion engine 17.

The swing motor 24 is provided with a revolution sensor 25m. The revolution sensor 25m detects the revolution speed of the swing motor 24. The revolution sensor 25m converts the detected revolution speed into an electrical signal and outputs the electrical signal to the hybrid controller 23. For example, a magnet-embedded synchronous motor is used as the swing motor 24. For example, a resolver or a rotary encoder is used as the revolution sensor 25m.

In this embodiment, the hybrid controller 23 includes a computer having a processor such as a central processing unit (CPU) and a memory. The hybrid controller 23 acquires signals of values detected by temperature sensors such as thermistors or thermocouples which are disposed in the generator motor 19, the swing motor 24, the electric power storage device 22, the swing motor control device 241, and the generator motor control device 19I to be described later. The hybrid controller 23 manages the temperatures of the devices such as the electric power storage device 22 based on the acquired temperatures and performs charging and discharging control of the electric power storage device 22, power generation control of the generator motor 19/assisting control of the internal combustion engine 17, and powering control/regenerative control of the swing motor 24. The hybrid controller 23 performs an engine control method according to this embodiment.

The drive system 1PS includes operation levers 26R and 26L which are disposed at right and left positions with respect to a seating position of an operator in the driver cabin 6 disposed in the vehicle body 2 illustrated in FIG. 1. The operation levers 26R and 26L are devices for operating the working implement 3 and operating travel of the excavator 1. The operation levers 26R and 26L operate the working implement 3 and the upper swing body 5 in response to the operations thereof.

A pilot hydraulic pressure is generated based on degrees of operation of the operation levers 26R and 26L. The pilot hydraulic pressure is supplied to a control valve to be described later. The control valve drives a spool of the working implement 3 depending on the pilot hydraulic pressure. With movement of the spool, the boom cylinder 14, the arm cylinder 15, and the bucket cylinder 16 are supplied with a hydraulic fluid. As a result, for example, lifting-up and lifting-down operations of the boom 11 are performed with the forward and backward operations of the operation lever 26R, excavation and dumping operations of the bucket 13 are performed with the rightward and leftward operations of the operation lever 26R. For example, dumping and excavation operations of the arm 12 are performed with the forward and backward operations of the operation lever 26L. The degrees of operation of the operation levers 26R and 26L are converted into electrical signals by a lever operation degree detecting unit 27. The lever operation degree detecting unit 27 includes a pressure sensor 27S. The pressure sensor 27S detects a pilot hydraulic pressure which is generated with the operations of the operation levers 26L and 26R. The pressure sensor 27S outputs a voltage corresponding to the detected pilot hydraulic pressure. The lever operation degree detecting unit 27 calculates a degree of lever operation by converting the voltage output from the pressure sensor 27S into a degree of operation.

The lever operation degree detecting unit 27 outputs the degree of lever operation as an electrical signal to at least one of a pump controller 33 and the hybrid controller 23. When the operation levers 26L and 26R are electrical levers, the lever operation degree detecting unit 27 includes an electrical detection device such as a potentiometer. The lever operation degree detecting unit 27 converts the voltage, which has been generated from the electrical detection device into the degree of lever operation depending on the degree of lever operation, to calculate the degree of lever operation. As a result, the swing motor 24 is driven in the right and left swing directions with the right and left operations of the operation lever 26L. The drive motor 21 is driven by right and left drive levers not illustrated.

A fuel adjustment dial 28 and a mode switching unit 29 are disposed in the driver cabin 6 illustrated in FIG. 1. In the following description, the fuel adjustment dial 28 is appropriately referred to as a throttle dial 28. The throttle dial 28 sets an amount of fuel supplied to the internal combustion engine 17. The set value (also referred to as a command value) of the throttle dial 28 is converted into an electrical signal and is output to an engine control device (hereinafter, appropriately referred to as an engine controller) 30.

The engine controller 30 acquires output values of sensors such as the revolution speed and the water temperature of the internal combustion engine 17 from sensors 17C for detecting states of the internal combustion engine 17. The engine controller 30 controls the output power of the internal combustion engine 17 by grasping the states of the internal combustion engine 17 from the acquired output values of the sensors 17C and adjusting the amount of fuel injected into the internal combustion engine 17. In this embodiment, the engine controller 30 includes a computer having a processor such as a CPU and a memory.

The engine controller 30 generates a signal of a control command for controlling the operation of the internal combustion engine 17 based on the set value of the throttle dial 28. The engine controller 30 transmits the generated control signal to a common rail control unit 32. The common rail control unit 32 receiving the control signal adjusts the amount of fuel injected into the internal combustion engine 17. That is, in this embodiment, the internal combustion engine 17 is a diesel engine which can be electronically controlled in a common rail manner. The engine controller 30 can cause the internal combustion engine 17 to generate target output power by controlling the amount of fuel injected into the internal combustion engine 17 via the common rail control unit 32. The engine controller 30 may freely set a torque which can be output at the revolution speed of the internal combustion engine 17 at any time.

The internal combustion engine 17 includes a revolution speed sensor 17n. The revolution speed sensor 17n detects the revolution speed of the output shaft 17S of the internal combustion engine 17, that is, the number of revolutions per unit time of the output shaft 17S. The engine controller 30 and the pump controller 33 acquire the revolution speed of the internal combustion engine 17 detected by the revolution speed sensor 17n and use the acquired revolution speed to control the operational state of the internal combustion engine 17. In this embodiment, the revolution speed sensor 17n may detect the number of revolutions of the internal combustion engine 17 and the engine controller 30 and the pump controller 33 may convert the number of revolutions into the revolution speed. In this embodiment, the actual revolution speed of the internal combustion engine 17 can be replaced with a value detected by the revolution sensor 25m of the generator motor 19.

The mode switching unit 29 is a unit that sets an operation mode of the excavator 1 to a power mode or an economy mode. The mode switching unit 29 includes, for example, an operation button, a switch, or a touch panel disposed in the driver cabin 6. The operator of the excavator 1 can switch the operation mode of the excavator 1 by operating the operation button or the like of the mode switching unit 29.

The pump controller 33 controls a flow rate of the hydraulic fluid ejected from the hydraulic pump 18. In this embodiment, the pump controller 33 includes a computer having a processor such as a CPU and a memory. The pump controller 33 receives signals transmitted from the engine controller 30, the mode switching unit 29, and the lever operation degree detecting unit 27. Then, the pump controller 33 generates a signal of a control command for adjusting the flow rate of the hydraulic fluid ejected from the hydraulic pump 18. The pump controller 33 changes the flow rate of the hydraulic fluid ejected from the hydraulic pump 18 by changing the swash plate angle of the hydraulic pump 18 using the generated control signal.

A signal of a swash plate angle sensor 18a for detecting the swash plate angle of the hydraulic pump 18 is input to the pump controller 33. The swash plate angle sensor 18a causes the pump controller 33 to calculate the pump capacity of the hydraulic pump 18 by detecting the swash plate angle. A pump pressure detecting unit 20a for detecting an ejection pressure of the hydraulic pump 18 (hereinafter, appropriately referred to as a pump ejection pressure) is disposed in a control valve 20. The detected pump ejection pressure is converted into an electrical signal and is input to the pump controller 33.

The engine controller 30, the pump controller 33, and the hybrid controller 23 are connected to each other via an in-vehicle local area network (LAN) 35 such as a controller area network (CAN). By employing this structure, the engine controller 30, the pump controller 33, and the hybrid controller 23 can interchange information with each other.

In this embodiment, at least the engine controller 30 controls the operational state of the internal combustion engine 17. In this case, the engine controller 30 controls the operational state of the internal combustion engine 17 using information generated from at least one of the pump controller 33 and the hybrid controller 23. In this way, in this embodiment, at least one of the engine controller 30, the pump controller 33, and the hybrid controller 23 serves as an engine control device of a hybrid work machine (hereinafter, appropriately referred to as an engine control device). That is, at least one of the controllers realizes an engine control method of a hybrid work machine (Hereinafter, appropriately referred to as an engine control method) according to this embodiment to control the operational state of the engine 36. In the following description, when the engine controller 30, the pump controller 33, and the hybrid controller 23 are not distinguished, these controllers may be referred to as an engine control device. In this embodiment, the hybrid controller 23 realizes the function of the engine control device.

<Control of Engine 36>

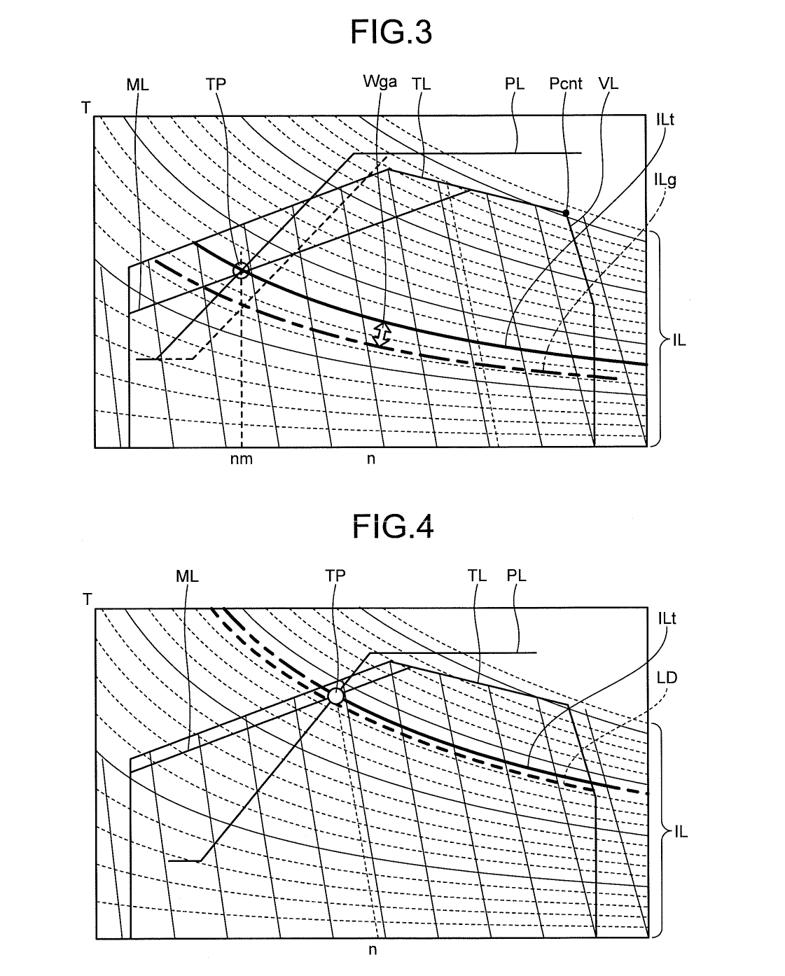

FIG. 3 is a diagram illustrating an example of a torque diagram which is used to control the engine 36 according to this embodiment. The torque diagram represents a relationship between the torque T (N×m) of the output shaft 17S of the internal combustion engine 17 and the revolution speed n (rpm: rev/min) of the output shaft 17S. In this embodiment, since the rotor 19R of the generator motor 19 is connected to the output shaft 17S of the internal combustion engine 17, the revolution speed n of the output shaft 17S of the internal combustion engine 17 is equal to the revolution speed of the rotor 19R of the generator motor 19. In the following description, the revolution speed n refers to at least one of the revolution speed of the output shaft 17S of the internal combustion engine 17 and the revolution speed of the rotor 19R of the generator motor 19. In this embodiment, the output power of the internal combustion engine 17 and the output power when the rotational motor 19 operates as an electric motor are horsepower and the unit thereof is power. The output power when the rotational motor 19 operates as a power generator is electric power and the unit thereof is power.

The torque diagram includes a maximum torque line TL, a limit line VL, a pump absorption torque line PL, a matching route ML, and an output instruction line IL. The maximum torque line TL, during operation of the excavator 1 illustrated in FIG. 1, indicates the maximum output power which can be generated by the internal combustion engine 17. The maximum torque line TL corresponds to the first relationship which is a relationship between the revolution speed n of the internal combustion engine 17 and the torque T which can be generated by the internal combustion engine 17 at the revolution speed n.

The torque T of the internal combustion engine 17 indicated by the maximum torque line TL is determined in consideration of durability, an exhaust smoke limit, and the like of the internal combustion engine 17. Accordingly, the internal combustion engine 17 can generate a torque larger than the torque T corresponding to the maximum torque line TL. In practice, the engine control device, for example, the engine controller 30, controls the internal combustion engine 17 such that the torque T of the internal combustion engine 17 does not exceed the maximum torque line TL.

At an intersection Pcnt of the limit line VL and the maximum torque line TL, the output power generated by the internal combustion engine 17 is a maximum. The intersection Pcnt is referred to as a rated point. The output power of the internal combustion engine 17 at the rated point Pcnt is referred to as rated output power. The maximum torque line TL is determined based on the exhaust smoke limit as described above. The limit line VL is determined based on the maximum revolution speed. Accordingly, the rated output power is the maximum output power of the internal combustion engine 17 which is determined based on the exhaust smoke limit and the maximum revolution speed of the internal combustion engine 17.

The limit line VL limits the revolution speed n of the internal combustion engine 17. That is, the revolution speed n of the internal combustion engine 17 is controlled so as not to be greater than the limit line VL by the engine control device, for example, the engine controller 30. The limit line VL defines the maximum revolution speed of the internal combustion engine 17. That is, the engine control device, for example, the engine controller 30, controls the maximum revolution speed of the internal combustion engine 17 so as not to exceed the revolution speed defined by the limit line VL into an over revolution.

The pump absorption torque line PL indicates the maximum torque which can be absorbed by the hydraulic pump 18 illustrated in FIG. 2 at the revolution speed n of the internal combustion engine 17. The matching route ML is set, for example, such that the revolution speed n is lowered with the same output power when the internal combustion engine 17 operates with predetermined output power. Accordingly, since the internal combustion engine 17 can be operated at a lower revolution speed, it is possible to reduce loss due to internal friction of the internal combustion engine 17. The matching route ML may be set to pass through a point with high fuel consumption.

The output instruction line IL indicates targets of the revolution speed n and the torque T of the internal combustion engine 17. That is, the internal combustion engine 17 is controlled to reach the revolution speed n and the torque T acquired from the output instruction line IL. Accordingly, the output instruction line IL corresponds to the second relationship which is a relationship between the torque T and the revolution speed n of the internal combustion engine 17 which is used to regulate the motive power generated from the internal combustion engine 17. The output instruction line IL is a command value of the output power (hereinafter, appropriately referred to as an output power command value) generated by the internal combustion engine 17. That is, the engine control device, for example, the engine controller 30, controls the torque T and the revolution speed n of the internal combustion engine 17 so as to reach the torque T and the revolution speed n on the output instruction line IL corresponding to the output power command value. For example, when the output instruction line ILt corresponds to the output power command value, the torque T and the revolution speed n of the internal combustion engine 17 are controlled to be values on the output instruction line ILt.

The torque diagram includes plural output instruction lines IL. The values between neighboring output instruction lines IL can be calculated, for example, by interpolation. In this embodiment, the output instruction lines IL are equal horsepower lines. In an equal horsepower line, the relationship between the torque T and the revolution speed n is determined such that the output power of the internal combustion engine 17 is constant. In this embodiment, the output instruction lines IL are not limited to the equal horsepower line, but may be equal throttle lines. An equal throttle line represents the relationship between the torque T and the revolution speed n when the set value (throttle opening) of the fuel adjustment dial, that is, the throttle dial 28, is the same. The set value of the throttle dial 28 is a command value which is used for the common rail control unit 32 to define an amount of fuel injected into the internal combustion engine 17. An example in which the output instruction line IL is an equal throttle line will be described later.

In this embodiment, the internal combustion engine 17 is controlled so as to reach the torque T and the revolution speed nm at a matching point TP. The matching point TP is an intersection of the matching route ML indicated by a solid line in FIG. 3, the output instruction line ILt indicated by a solid line in FIG. 3, and the pump absorption torque line PL indicated by a solid line. The matching point TP is a point at which the output power of the internal combustion engine 17 and the load of the hydraulic pump 18 are balanced with each other. The output instruction line ILt indicated by the solid line corresponds to the target of the output power of the internal combustion engine 17 which is absorbed by the hydraulic pump 18 and the target output power of the internal combustion engine 17 at the matching point TP.

When the generator motor 19 generates electric power, the output power of the internal combustion engine 17 which is absorbed by the hydraulic pump 18 decreases by the output power Wga which is absorbed by the generator motor 19. The pump absorption torque line PL moves to a position indicated by a dotted line. At this time, the output power corresponds to an output instruction line ILg. The pump absorption torque line PL intersects the output instruction line ILg at the revolution speed nm at the matching point TP. An output instruction line ILt passing through the matching point TP is obtained by adding the output power Wga absorbed by the generator motor 19 to the output instruction line ILg.

In this way, the engine 36, that is, the internal combustion engine 17 and the generator motor 19, is controlled based on the maximum torque line TL, the limit line VL, the pump absorption torque line PL, the matching route ML, and the output instruction lines IL. A case in which a load acting on the engine 36, more specifically, the internal combustion engine 17, temporarily varies will be described below.

<When Load Acting on Internal Combustion Engine 17 Temporarily Varies>

FIG. 4 is a diagram illustrating an operational state of the internal combustion engine 17. In normal operation of the engine 36, a load acting on the engine 36, more specifically, the internal combustion engine 17, is not greater than the output power command value. That is, the engine controller 30 illustrated in FIG. 2 performs control such that the load LD acting on the internal combustion engine 17 is not greater than the output instruction line ILt as illustrated in FIG. 4. However, during operation of the engine 36, the load acting on the engine 36, more specifically, the internal combustion engine 17, may temporarily varies, for example, due to disturbance.

Even when a large external force acts on the working implement 3, the load acting on the internal combustion engine 17 may temporarily vary. For example, when a large external force suddenly acts on the working implement 3, the internal pressure of the hydraulic cylinder for driving the working implement 3 rapidly increases and thus the pressure of the hydraulic pump 18 rapidly increases via a hydraulic pipe. When the pressure of the hydraulic pump 18 rapidly increases in a state in which the flow rate of the hydraulic fluid ejected from the hydraulic pump 18 does not vary, the absorptive horsepower of the hydraulic pump 18 rapidly increases. In general, when the pressure of the hydraulic pump 18 increases, the hydraulic circuit is controlled such that the swash plate angle of the hydraulic pump 18 decreases. Accordingly, the output power of the internal combustion engine 17 is suppressed by suppressing the flow rate of the hydraulic fluid ejected from the hydraulic pump 18, that is, the product of the swash plate angle and the revolution speed of the internal combustion engine 17. In this way, the control of decreasing the flow rate of the hydraulic fluid ejected from the hydraulic pump 18 is performed such that the absorptive horsepower of the hydraulic pump 18 is not greater than a target absorptive horsepower, but when the load acting on the internal combustion engine 17 rapidly varies, the above-mentioned control may not follow the rapid variation. Even when the torque required for causing the generator motor 19 to generate electric power rapidly increases, the load acting on the internal combustion engine 17 may temporarily vary.

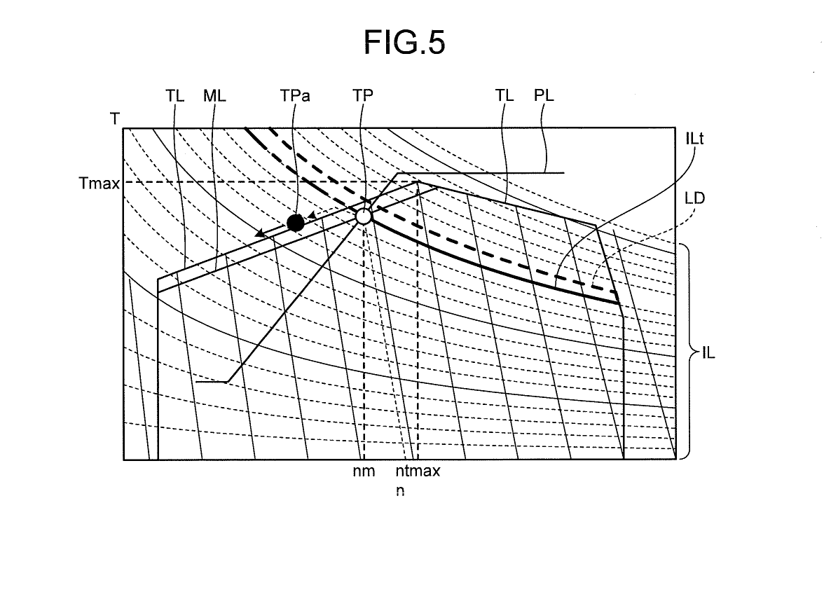

FIG. 5 is a diagram illustrating a state in which the load of the internal combustion engine 17 increases. For example, when the load acting on the internal combustion engine 17 rapidly increases due to disturbance or the like, the load greater than the output power command value may act on the internal combustion engine 17. In the example illustrated in FIG. 5, the engine controller 30 controls the internal combustion engine 17 so as to reach the torque T and the revolution speed nm at the matching point TP on the output instruction line ILt, but the load LD may exceed the output instruction line ILt due to disturbance or the like.

Then, since energy (inertial energy) for holding the revolution speed n is consumed in the internal combustion engine 17, the revolution speed n decreases. When the revolution speed n decreases, the torque T of the internal combustion engine 17 increases up to the torque T of the maximum torque line TL along the output instruction line ILt. Thereafter, the torque T and the revolution speed n of the internal combustion engine 17 decrease along the maximum torque line TL as indicated by a point TPa in FIG. 5. In general, the increase in the load LD due to disturbance or the like is temporary and the load rapidly becomes equal to or less than the output power command value. When the torque T and the revolution speed n of the internal combustion engine 17 decrease along the maximum torque line TL, there is a possibility that the revolution speed n of the internal combustion engine 17 will continue to decrease and will cause a decrease in the revolution speed n or the stop of the internal combustion engine 17 even when the load LD of the internal combustion engine 17 is equal to or less than the output power command value. This phenomenon occurs in a range in which the revolution speed n of the internal combustion engine 17 is equal to or less than the revolution speed ntmax at the maximum value TLmax of the maximum torque line TL.

In order to suppress this phenomenon, the engine control device, more specifically, the hybrid controller 23 illustrated in FIG. 2, performs the engine control method according to this embodiment. That is, the hybrid controller 23 drives the generator motor 19 illustrated in FIG. 2 as an electric motor when a load LD greater than a command value for defining motive power generated from the internal combustion engine 17, that is, the output power command value, temporarily acts on the internal combustion engine 17. When the generator motor 19 is driven as an electric motor, the torque T of the generator motor 19 is given to the internal combustion engine 17 and thus the decrease in the revolution speed n of the internal combustion engine 17 is suppressed. As a result, after the load LD temporarily increasing greater than the output power command value is returned to be equal to or less than the output power command value, the internal combustion engine 17 can continue to operate at the torque T and the revolution speed nm at the matching point TP.

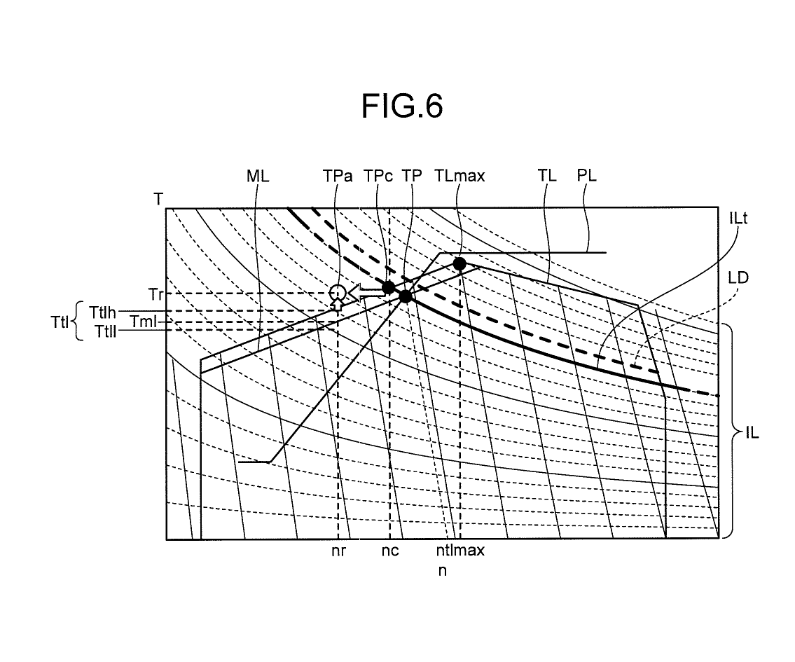

FIGS. 6 to 8 are diagrams illustrating the control of the engine control device according to this embodiment. In the control of the engine control device according to this embodiment (hereinafter, appropriately referred to as engine control), the hybrid controller 23 outputs a drive command for driving the generator motor 19 to cause the generator motor 19 to generate motive power when both a first condition and a second condition are satisfied. The first condition and the second condition will be described below with reference to FIG. 6.

Whether to satisfy the first condition or not is determined based on a result of comparison of the actual revolution speed nr of the internal combustion engine 17 with the revolution speed nc acquired from the maximum torque line TL and the output instruction line ILt. The actual revolution speed nr of the internal combustion engine 17 is a real revolution speed of the internal combustion engine 17 in the engine control. In this embodiment, the actual revolution speed nr is a revolution speed which is acquired from the revolution sensor 25m for detecting the revolution speed of the generator motor 19 by the hybrid controller 23 illustrated in FIG. 2. The first condition is satisfied when the actual revolution speed nr of the internal combustion engine 17 is equal to or less than the revolution speed (hereinafter, appropriately referred to as a control-determination revolution speed) nc which is acquired from the maximum torque line TL and the output instruction line ILt. The control-determination revolution speed nc is a revolution speed at an intersection TPc at which the maximum torque line TL and the output instruction line ILt intersect each other.

Even when the first condition is satisfied but the torque T of the internal combustion engine 17 is less than the maximum torque line TL, the generator motor 19 operates as an electric motor, and thus there is a possibility that the electric power of the electric power storage device 22 will be consumed and the fuel efficiency of the internal combustion engine 17 will decrease. When the actual revolution speed nr moves up and down with respect to the control-determination revolution speed nc, there is a possibility that the operation of the generator motor 19 as an electric motor and the operation as a power generator will be repeated. That is, there is a possibility that hunting will occur when only the first condition is satisfied. In this embodiment, the generator motor 19 is driven as an electric motor when a second condition to be described below is satisfied in addition to the first condition. Accordingly, it is possible to suppress the possibilities that the fuel efficiency of the internal combustion engine 17 will decrease and the above-mentioned hunting will occur.

Whether to satisfy the second condition or not is determined based on a result of comparison of the torque Tr of the internal combustion engine 17 at the actual revolution speed nr with the torque Ttl which is acquired using the maximum torque line TL at the actual revolution speed nr. The torque Tr is acquired by the hybrid controller 23 by receiving the value calculated by the engine controller 30 illustrated in FIG. 2 by communication via the in-vehicle LAN 35. The engine controller 30 acquires the revolution speed n of the internal combustion engine 17 detected by the revolution speed sensor 17n and outputs the torque Ttlh on the maximum torque line TL corresponding to the acquired revolution speed n as the torque Tr of the internal combustion engine 17 to the hybrid controller 23. The second condition is satisfied when the torque Tr of the internal combustion engine 17 at the actual revolution speed nr is equal to or greater than the torque Ttlh acquired from the maximum torque line TL at the actual revolution speed nr.

The second condition may be satisfied when the torque Tr of the internal combustion engine 17 at the actual revolution speed nr is equal to or greater than a threshold value Ttll which is smaller by a predetermined magnitude than the torque Ttlh acquired from the maximum torque line TL at the actual revolution speed nr. In this case, even when the torque Tr acquired by the engine controller 30 has a deviation, the hybrid controller 23 can satisfactorily determine the second condition.

The predetermined magnitude is not particularly limited, but may be set, for example, to a value which is smaller than a difference Δ between the torque Ttlh acquired from the maximum torque line TL at the actual revolution speed nr and the torque Tml acquired from the matching route ML at the actual revolution speed nr. The difference Δ is Ttlh−Tml. For example, the predetermined magnitude may be determined in a range of 5% to 80% of the difference Δ. The predetermined magnitude may be set to a range of 1% to 10% of the torque Ttlh acquired from the maximum torque line TL at the actual revolution speed nr. In this case, the threshold value Ttll ranges from 90% to 99% of the torque Ttlh.

Since the maximum torque line TL is a set of maximum torques T which can be generated from the internal combustion engine 17 at the revolution speeds n, the torque T which is actually generated from the internal combustion engine 17 is not greater than the torque T determined by the maximum torque line TL. In this embodiment, it is assumed that the second condition is satisfied even when the torque Tr of the internal combustion engine 17 is greater than the torque Ttlh acquired from the maximum torque line TL at the actual revolution speed nr. That is, in this embodiment, it is considered that the torque Tr of the internal combustion engine 17 is greater than the torque T determined from the maximum torque line TL.

As described above, the actual revolution speed nr is a revolution speed which is acquired from the revolution sensor 25m for determining the revolution speed of the generator motor 19 by the hybrid controller 23. The torque Tr of the internal combustion engine 17 corresponding to the actual revolution speed nr is acquired from the engine controller 30 by communication via the in-vehicle LAN 35 by the hybrid controller 23 in a control cycle in which the hybrid controller 23 acquires the revolution speed nr from the revolution sensor 25m. Accordingly, when a delay occurs in the communication via the in-vehicle LAN 35, there is a possibility that the hybrid controller 23 will acquire the torque Tr in a control cycle previous to the control cycle in which the revolution speed nr is acquired from the revolution sensor 25m.

When the load LD is greater than the output power command value at the revolution speed ntlmx or less, the torque T of the internal combustion engine 17 decreases with a decrease in the revolution speed n. Accordingly, when a delay occurs in the communication via the in-vehicle LAN 35, it is thought that the torque Tr acquired from the engine controller 30 by the hybrid controller 23 is higher than the actual torque of the internal combustion engine 17. In this embodiment, it is assumed as described above that the second condition is satisfied when the torque Tr of the internal combustion engine 17 is equal to or greater than the torque Ttlh acquired from the maximum torque line TL at the actual revolution speed nr. Accordingly, even when a delay occurs in the communication via the in-vehicle LAN 35, the hybrid controller 23 can satisfactorily determine the second condition.

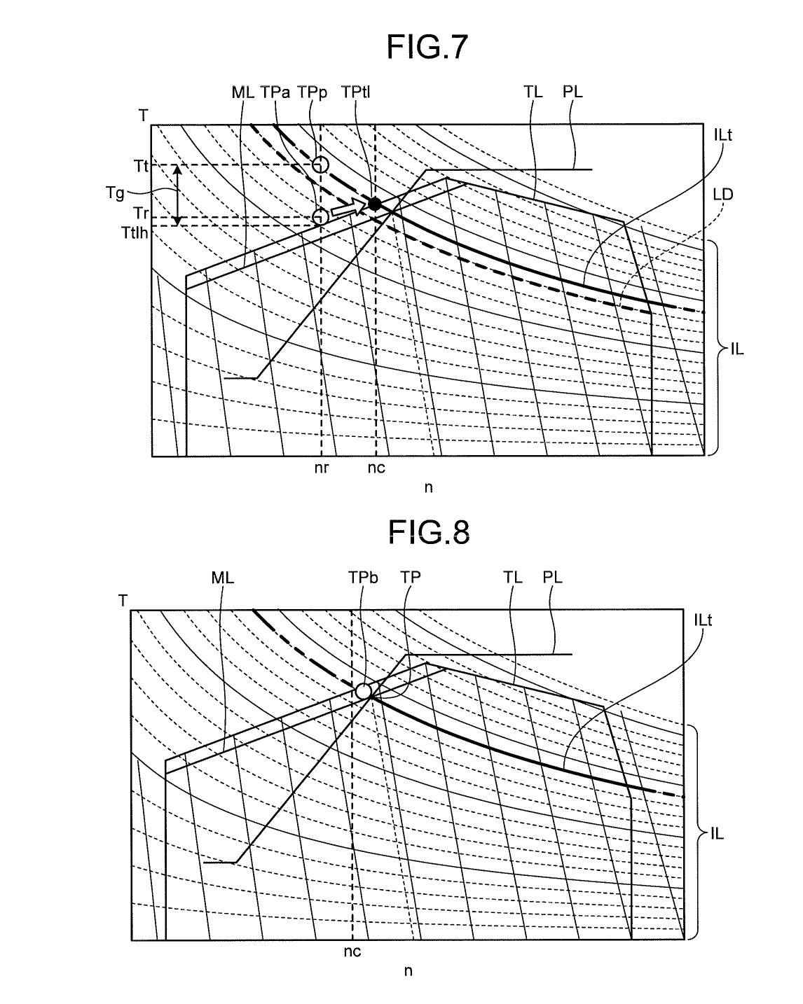

The torque generated from the generator motor 19 will be described below with reference to FIG. 7. When the first condition and the second condition are satisfied, the hybrid controller 23 drives the generator motor 19 as an electric motor. In this case, the hybrid controller 23 determines the torque (hereinafter, appropriately referred to as a generator motor torque) Tg generated from the generator motor 19 based on the torque Tt acquired from the output instruction line ILt at the actual revolution speed nr and the torque Ttlh acquired from the maximum torque line TL at the actual revolution speed nr. Specifically, the generator motor torque Tg is a difference between the torque Tt or and the torque Ttlh. The torque Tt acquired from the output instruction line ILt at the actual revolution speed nr is the torque at the point TPp on the output instruction line ILt at the actual revolution speed nr.

The hybrid controller 23 controls the generator motor control device 19I illustrated in FIG. 2 so as to reach the acquired generator motor torque Tg and supplies electric power to the generator motor 19 from the electric power storage device 22. At this time, the torque T generated from the engine 36 is the sum of the torque Ttlh acquired from the maximum torque line TL at the actual revolution speed nr and the generator motor torque Tg, that is, the torque Tt acquired from the output instruction line ILt at the actual revolution speed nr. When the load LD becomes less than the output power command value corresponding to the output instruction line ITt by this control, the output power of the engine 36, that is, the sum of the output power of the internal combustion engine 17 and the output power of the generator motor 19, becomes greater than the load LD. Since the difference between the output power of the engine 36 and the load LD serve as energy for increasing the revolution speed n of the internal combustion engine 17, the revolution speed n of the internal combustion engine 17 increases as indicated by an arrow in FIG. 7.

When the revolution speed n of the internal combustion engine 17 increases, the point TPb indicating the operational state of the internal combustion engine 17 illustrated in FIG. 8 is returned to the matching point TP before the load LD increases. Since the internal combustion engine 17 continues to operate at the matching point TP before the load LD increases, stop of the internal combustion engine 17 is avoided. In this way, by performing the engine control according to this embodiment, the hybrid controller 23 drives the generator motor 19 as an electric motor even when the load acting on the internal combustion engine 17 temporarily varies, specifically, temporarily increases, and thus it is possible to reduce the possibility that the internal combustion engine 17 will stop.

When the generator motor 19 is driven as an electric motor, the electric power stored in the electric power storage device 22. Accordingly, when it is not necessary to drive the generator motor 19 as an electric motor, the hybrid controller 23 causes the generator motor 19 to generate electric power to store the electric power to the electric power storage device 22. That is, the hybrid controller 23 switches the state in which the generator motor 19 generates motive power to the state in which the generator motor 19 generates electric power. When it is not necessary to drive the generator motor 19 as an electric motor, the actual revolution speed nr of the internal combustion engine 17 is greater than the control-determination revolution speed nc. A case in which the operational state of the generator motor 19 is switched will be described below.

<When Operational State of Generator Motor 19 is Switched>

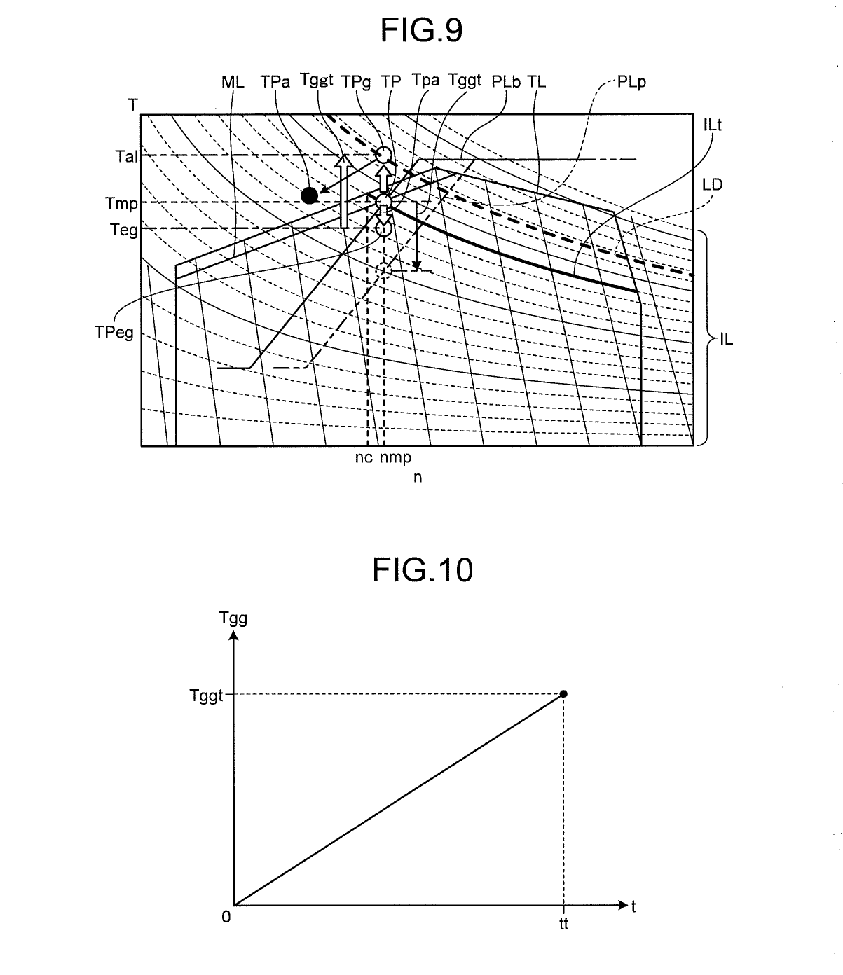

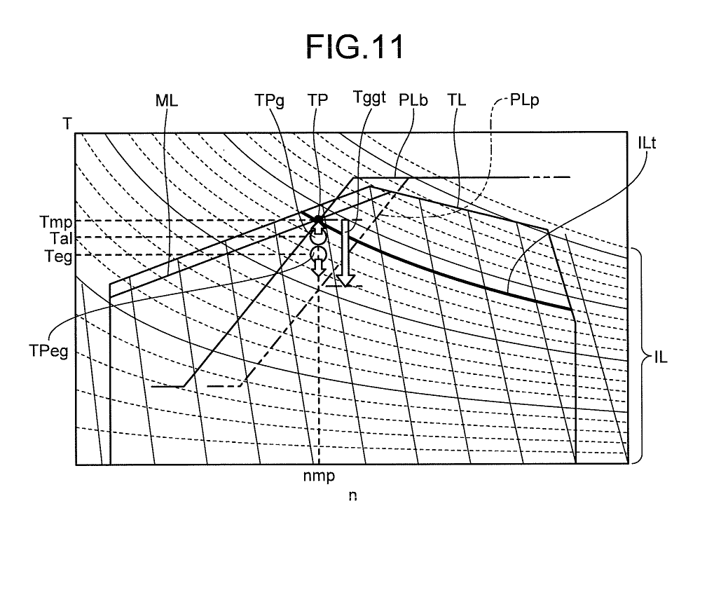

FIG. 9 is a diagram illustrating the operation of the engine 36 when the first condition is not satisfied and the generator motor 19 generates electric power. FIG. 10 is a diagram illustrating a variation example of a torque Tgg with respect to the time t when the generator motor 19 generates electric power. FIG. 11 is a diagram illustrating then operation of the engine 36 when the first condition is not satisfied and the generator motor 19 generates electric power in the engine control according to this embodiment.

By driving the generator motor 19 as an electric motor when the load LD is greater than the output power command value, the internal combustion engine 17 operates at the matching point TP before the load LD becomes greater than the output power command value. At this time, in order to store electric power in the electric power storage device 22, the hybrid controller 23 causes the generator motor 19 to generate electric power. The generator motor 19 is driven by the internal combustion engine 17 with a torque (hereinafter, appropriately referred to as driven torque) Tggt which is acquired from an amount of electric power generated necessary for charging the electric power storage device 22.

When the actual revolution speed nr of the internal combustion engine 17 is higher than the control-determination revolution speed nc, the hybrid controller 23 switches the operational state of the generator motor 19 from driving to power generation. In this case, the hybrid controller 23 does not change the output power command value for the internal combustion engine 17 but decreases a command value of the pump absorption torque Tpa (hereinafter, appropriately referred to as a pump absorption torque command value) by the driven torque Tggt. Specifically, a pump absorption torque line PLb which is indicated by a solid line and defines the current matching point TP moves to a pump absorption torque line PLp.

Even when the pump absorption torque command value is decreased, the actual pump absorption torque Tpa slowly decreases due to a response delay in controlling the hydraulic pump 18. Accordingly, a time is required until the actual pump absorption torque Tpa decreases by the driven torque Tggt. Since the generator motor 19 responses to a power generation command without almost a time delay, the driven torque Tggt acts on the internal combustion engine 17 without almost a delay in response to the power generation command. As a result, when the driven torque Tggt when the operational state of the generator motor 19 is switched to power generation is large, the load LD equal to or greater than the output power command value acts on the internal combustion engine 17.

Specifically, when a power generation command is given to the generator motor 19 and the driven torque Tggt acts on the internal combustion engine 17, the actual pump absorption torque has a value at a point TPeg, that is, Teg. In this way, when the driven torque Tggt acts on the internal combustion engine 17, a state in which the actual pump absorption torque does not completely decrease by the driven torque Tggt occurs. Then, a torque Tal obtained by adding the pump absorption torque Teg and the driven torque Tggt acts on the internal combustion engine 17 at the revolution speed nmp at the matching point TP. As illustrated in FIG. 9, when the torque Tal at the revolution speed nmp at the matching point TP is greater than the torque Tmp at the matching point TP, the load LD greater than the output power corresponding to the output instruction line ILt passing through the matching point TP acts on the internal combustion engine 17. Then, the revolution speed n of the internal combustion engine 17 decreases and the generator motor 19 is driven as an electric motor again. As a result, there is a possibility that the hunting phenomenon in which the generator motor 19 repeats generation of motive power as an electric motor and generation of electric power as a power generator will occur.

Accordingly, when the operational state of the generator motor 19 is switched from the driving state to the power generation state, the hybrid controller 23 performs modulation on the driven torque Tggt which is a command value (hereinafter, appropriately referred to as a power generation command value) for causing the generator motor 19 to generate electric power and outputs the resultant, as illustrated in FIG. 11. The driven torque subjected to the modulation is denoted by Tgg. When the modulation is performed on the driven torque Tggt, the driven torque Tgg increases from 0 with the lapse of time t and becomes a target driven torque Tggt at time tt, as illustrated in FIG. 10. A point TPg in FIG. 11 represents the variation of the driven torque Tgg and the point Tpeg represents the variation of the pump absorption torque Teg.

In this way, the hybrid controller 23 changes (increases in this embodiment) the power generation command value from a value smaller than a target value with the lapse of time and outputs the increased power generation command value to control the generator motor 19. By this control, the power generation command value, that is, the driven torque Tgg, slowly increases and reaches the driven torque Tggt as a target value. Accordingly, even when the actual pump absorption torque Tpa slowly decreases due to the response delay in controlling the hydraulic pump 18, the torque Tal obtained by adding the pump absorption torque Teg and the driven torque Tgg subjected to the modulation is prevented from being greater than the torque Tmp at the matching point TP. When the operational state of the generator motor 19 is switched to the power generation state, the decrease of the revolution speed n of the internal combustion engine 17 is suppressed and it is thus possible to suppress the above-mentioned hunting.

<Modification of Output Instruction Line>

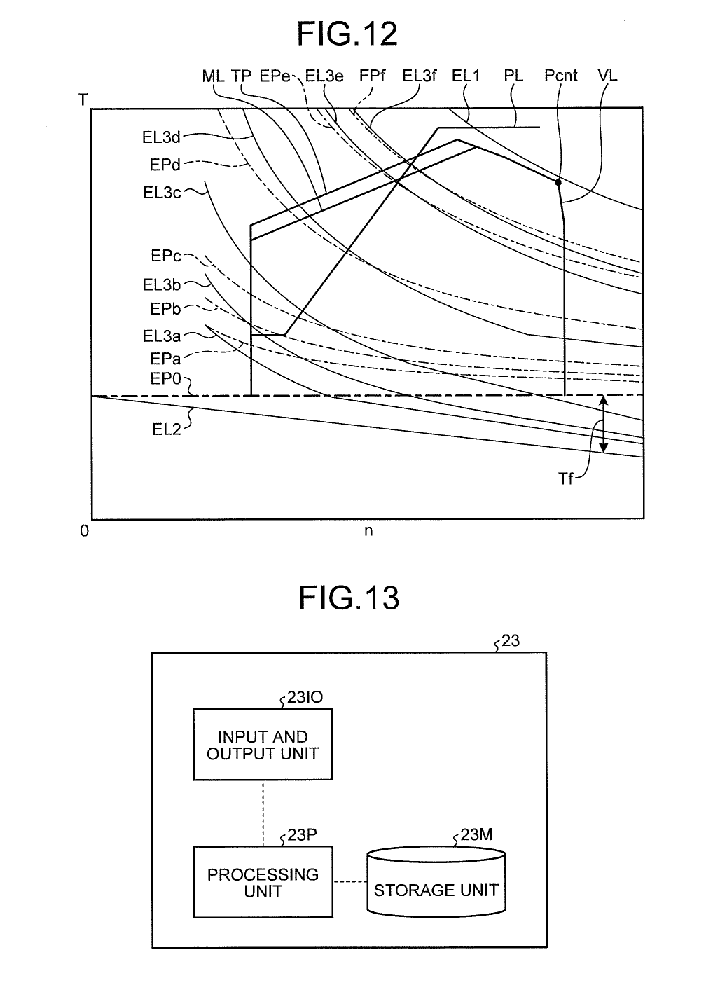

FIG. 12 is a diagram illustrating a modification of the output instruction line according to the embodiment. As described above, the output instruction lines IL illustrated in FIGS. 3 to 9 and FIG. 10 are equal horsepower lines, but the output instruction lines in the modification are equal throttle lines. The torque diagram illustrated in FIG. 12 includes equal throttle lines EL1, EL2, EL3a, EL3b, EL3c, EL3d, EL3e, and EL3f, equal horsepower lines EP0, EPa, EPb, EPc, EPd, EPe, and EPf, limit lines VL, HL, and LL, the maximum torque line TL of the internal combustion engine 17, the pump absorption torque line PL, and the matching route ML.

The equal throttle lines EL1, EL2, EL3a, EL3b, EL3c, EL3d, EL3e, and EL3f represent the relationships between the torque T and the revolution speed n when the set value of the fuel adjustment dial, that is, the set value of the throttle dial 28 (throttle opening) illustrated in FIG. 2, is the same. The set value of the throttle dial 28 is a command value used for the common rail control unit 32 to define an amount of fuel injected into the internal combustion engine 17.

In the modification, the set value of the throttle dial 28 is expressed by a percentage which is set to 0% when the amount of fuel injected into the internal combustion engine 17 is 0 and which is set to 100% when the amount of fuel injected into the internal combustion engine 17 is the maximum. In the modification, when the engine control device controls the operational state of the internal combustion engine 17, the case in which the amount of fuel injected into the internal combustion engine 17 is a maximum does not correspond to the case in which the output power of the internal combustion engine 17 is a maximum.

The equal throttle line EL1 corresponds to a case in which the set value of the throttle dial 28 is 100%, that is, a case in which the amount of fuel injected into the internal combustion engine 17 is a maximum. The equal throttle line EL2 corresponds to a case in which the set value of the throttle dial 28 is 0. The equal throttle lines EL3a, EL3b, EL3c, EL3d, EL3e, and EL3f correspond to cases of the set value of the throttle dial 28 increases in this order.

Comparing the equal throttle lines EL1, EL2, and EL3a to EL3f when the revolution speed n of the internal combustion engine 17 is the same, the amount of fuel injected in the equal throttle line EL1 is a maximum and the amount of fuel injected in the equal throttle line EL2 is a minimum, that is, 0. The amounts of fuel injected in the equal throttle lines EL3a, EL3b, EL3c, EL3d, EL3e, and EL3f increase in this order.

That is, the equal throttle line EL1 represents a third relationship between the torque T and the revolution speed n which corresponds to the case in which the amount of fuel injected into the internal combustion engine 17 is a maximum. In the following description, the equal throttle line EL1 is appropriately referred to as a first equal throttle line EL1. In the modification, the first equal throttle line EL1 is an equal horsepower line of the internal combustion engine 17, that is, a line indicating that the output power of the internal combustion engine 17 is constant. In the first equal throttle line EL1, the output power at the revolution speed at which the output power of the internal combustion engine 17 is the rated output power is equal to or greater than the rated output power. In the modification, the first equal throttle line EL1 is described to be an equal horsepower line, but is not limited thereto.

The equal throttle line EL2 represents a fourth relationship between the torque T and the revolution speed n which corresponds to the case in which the amount of fuel injected into the internal combustion engine 17 is 0. In the equal throttle line EL2, the torque T of the internal combustion engine 17 is determined to decrease as the revolution speed n of the internal combustion engine 17 increases from a start point at which the torque T of the internal combustion engine 17 is 0 and the revolution speed n is 0. The ratio at which the torque T decreases is determined based on a frictional torque Tf generated due to internal friction of the internal combustion engine 17. In the following description, the equal throttle line EL2 is appropriately referred to as a second equal throttle line EL2.

The frictional torque Tf corresponds to loss due to the internal friction of the internal combustion engine 17. In the torque diagram illustrated in FIG. 12, the torque output from the internal combustion engine 17 is defined as positive. Accordingly, in the torque diagram illustrated in FIG. 12, the frictional torque Tf has a negative value. The frictional torque Tf increases with an increase in the revolution speed n. The second equal throttle line EL2 can be calculated from the relationship of the frictional torque Tf to the revolution speed n of the internal combustion engine 17.

The equal throttle lines EL3a, EL3b, EL3c, EL3d, EL3e, and EL3f are present between the first equal throttle line EL1 and the second equal throttle line EL2. The equal throttle lines EL3a, EL3b, EL3c, EL3d, EL3e, and EL3f represent the third relationship between the torque T and the revolution speed n which is acquired from the values of the first equal throttle line EL1 and the second equal throttle line EL2. In this embodiment, the equal throttle lines EL3a, EL3b, EL3c, EL3d, EL3e, and EL3f are acquired by interpolation using the values of the first equal throttle line EL1 and the second equal throttle line EL2. For example, linear interpolation is used as the interpolation. The method of acquiring the equal throttle lines EL3a, EL3b, EL3c, EL3d, EL3e, and EL3f is not limited to the interpolation.

In the following description, the equal throttle lines EL3a, EL3b, EL3c, EL3d, EL3e, and EL3f are appropriately referred to as third equal throttle lines EL3a, EL3b, EL3c, EL3d, EL3e, and EL3f. When plural third equal throttle lines EL3a, EL3b, EL3c, EL3d, EL3e, and EL3f do not need to be distinguished, these throttle lines are referred to as the equal throttle line EL3 or the third equal throttle line EL3.

In the example illustrated in FIG. 12, the number of third throttle lines EL3 is six and the third equal throttle lines EL3 only has to be present between the first equal throttle line EL1 and the second equal throttle line EL3. Accordingly, the number of third equal throttle lines EL3 is not limited. The gap between the neighboring third equal throttle lines EL3 is not limited.

all the first equal throttle line EL1, the second equal throttle line EL2, and the third equal throttle lines EL3 represent targets of the revolution speed n and the torque T of the internal combustion engine 17. That is, the internal combustion engine 17 is controlled to reach the revolution speed n and the torque T which are acquired from the first equal throttle line ELL the second equal throttle line EL2, and the third equal throttle lines EL3.

In the equal horsepower lines EP0, EPa, EPb, EPc, EPd, EPe, and EPf, the relationship between the torque T and the revolution speed n is determined such that the output power of the internal combustion engine 17 is constant. The output power of the internal combustion engine 17 increases sequentially in the order of the equal horsepower lines EP0, EPa, EPb, EPc, EPd, EPe, and EPf. The equal horsepower line EP0 corresponds to the case in which the output power of the internal combustion engine 17 is 0. In this embodiment, the equal horsepower lines EP0, EPa, EPb, EPc, EPd, EPe, and EPf correspond to the fourth relationship between the torque T and the revolution speed n. When the equal horsepower lines EP0, EPa, EPb, EPc, EPd, EPe, and EPf do not need to be distinguished, these equal horsepower lines are referred to as equal horsepower lines EP. The equal horsepower lines EP have a function of limiting the output power of the internal combustion engine 17 so as not to exceed the output power defined by the equal horsepower lines EP. The output instruction lines IL according to the embodiment is the equal horsepower lines EP as described above.

In the second equal throttle line EL2, the torque T decreases along a linear function when the revolution speed n of the internal combustion engine 17 increases. The third equal throttle lines EL3 are acquired by interpolation using the first equal throttle line EL1 and the second equal throttle line EL2. Accordingly, the equal horsepower lines EP and the third equal throttle lines EL3 corresponding to the equal horsepower lines EP intersect each other at one point. For example, the equal horsepower line EP corresponding to half the maximum output power of the internal combustion engine 17 corresponds to the third equal throttle line EL3 corresponding to 50% of the throttle opening and both intersect each other at one point. The limit line VL, the maximum torque line TL, the matching route ML, the pump absorption torque line PL, and the rated point Pcnt are the same as in the above-mentioned embodiment.

The engine control device, for example, the engine controller 30 illustrated in FIG. 2, controls the operational state of the internal combustion engine 17 using the first equal throttle line EL1, the second equal throttle line EL2, and the third equal throttle lines EL3 acquired by interpolation using both equal throttle lines in the same way as in the above-mentioned embodiment. For example, the engine controller 30 can control the internal combustion engine 17 so as to reach the torque T and the revolution speed n at the matching point TP at which the third equal throttle line EL3 corresponding to the instruction value of the throttle dial 28, the matching route ML, and the pump absorption torque line PL intersect.

In the modification, the engine controller 30 stores at least information of the first equal throttle line EL1, the second equal throttle line EL2, and the third equal throttle lines EL3 acquired by interpolation both throttle lines in a storage device thereof, and controls the operational state of the internal combustion engine 17 based on the stored information and the set value of the throttle dial 28. Accordingly, the engine controller 30 can control the operational state of the internal combustion engine 17 only when the set value of the throttle dial 28 is input. Therefore, without any controller other than the engine controller 30, for example, without using the pump controller 33 and the like, it is possible to control the internal combustion engine 17 by only generating the set value of the throttle dial 28 using the engine controller 30. As a result, a degree of freedom and versatility in controlling the operational state of the internal combustion engine 17 are improved using the engine controller 30. For example, when it is wanted to test performance of only the internal combustion engine 17, it is possible to test only the internal combustion engine 17 by giving the set value of the throttle dial 28 to the engine controller 30.

The pump controller 33 or another control device of the excavator 1 illustrated in FIG. 1 may control the internal combustion engine 17 via the engine controller 30. In this case, the pump controller 33 and the like only has to convert a command value of the output power generated from the internal combustion engine 17 into the set value of the throttle dial 28 and supply the set value to the engine controller 30. Since the set value of the throttle dial 28 is expressed by a percentage between 0% and 100%, it is possible to relatively simply generate the set value. Accordingly, another control device of the excavator 1 can relatively simply control the internal combustion engine 17 using the set value of the throttle dial 28.

<Configuration Example of Hybrid Controller 23>

FIG. 13 is a diagram illustrating a configuration example of the hybrid controller 23 that performs the engine control according to this embodiment. The hybrid controller 23 includes a processing unit 23P, a storage unit 23M, and an input and output unit 23IO. The processing unit 23P includes a processor such as a CPU and a memory. The processing unit 23P performs the engine control according to this embodiment.

The storage unit 23M includes at least one of nonvolatile or volatile semiconductor memory such as random access memory (RAM), random access memory (ROM), flash memory, erasable programmable random access memory (EPROM), and electrically erasable programmable random access memory (EEPROM), a magnetic disk, a flexible disk, and a magneto-optical disc. The storage unit 23M stores a computer program for causing the processing unit 23P to perform the engine control according to this embodiment and information which is used for the processing unit 23P to perform the engine control according to this embodiment. The processing unit 23P realizes the engine control according to this embodiment by reading the above-mentioned computer program from the storage unit 23M and executing the read computer program.

The input and output unit 23IO is an interface circuit for connecting devices to the hybrid controller 23. The input and output unit 23IO is connected to the mode switching unit 29, the fuel adjustment dial 28, the swing motor control device 241, the generator motor control device 19I, the pressure sensor 27S, and the in-vehicle LAN 35 illustrated in FIG. 2.

<Control Block of Hybrid Controller 23>

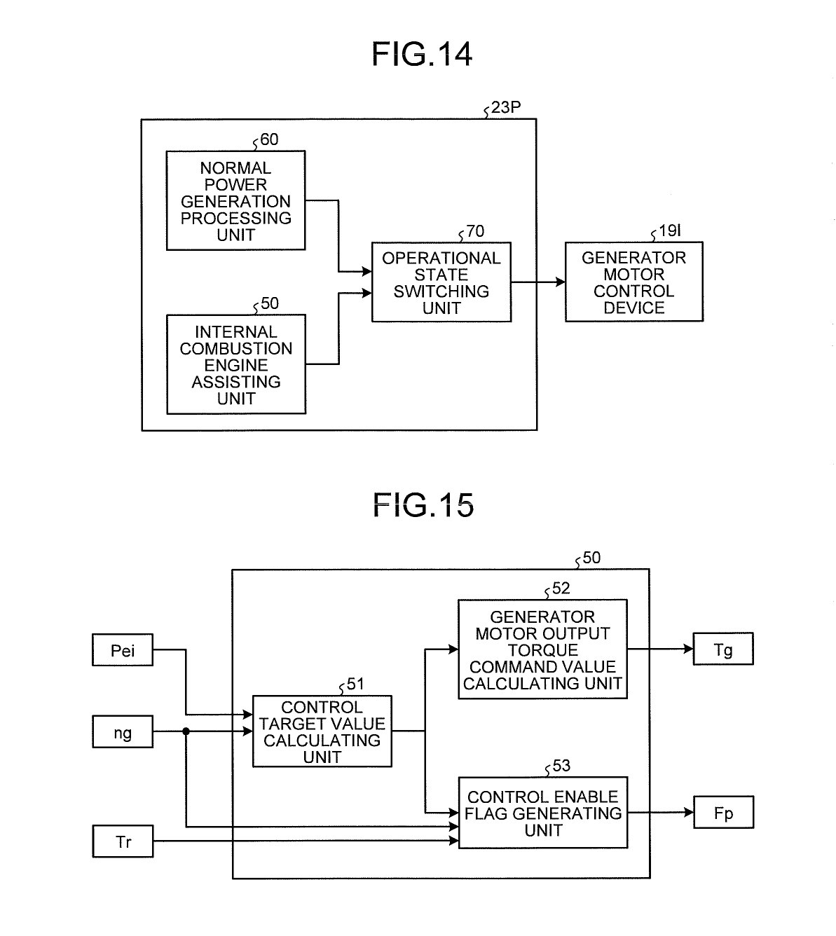

FIGS. 14 to 19 are control block diagrams of the hybrid controller 23 that performs the engine control according to this embodiment. In order to perform the engine control according to this embodiment, the processing unit 23P of the hybrid controller 23 includes an internal combustion engine assisting unit 50, a normal power generation processing unit 60, and an operation pattern switching unit 70 as illustrated in FIG. 14. The internal combustion engine assisting unit 50 performs the process of driving the generator motor 19 as an electric motor. The normal power generation processing unit 60 performs the process of causing the generator motor 19 to generate electric power when the state in which the generator motor 19 generates motive power is switched to the state in which the generator motor 19 generates electric power. The operation pattern switching unit 70 switches the operational state between the state in which the generator motor 19 generates motive power and the state in which the generator motor 19 generates electric power during operation of the generator motor 19.

The operation pattern switching unit 70 outputs a command for switching between the operation as an electric motor and the operation as a power generator and a command value of the target torque of the generator motor 19 to the inverter 19I for driving the generator motor 19. When the first condition and the second condition are satisfied, the operation pattern switching unit 70 outputs a command for causing the generator motor 19 to operate as an electric motor and the command value of the target torque of the generator motor 19. When the first condition and the second condition are satisfied, the operation pattern switching unit 70 outputs a command for causing the generator motor 19 to operate as an electric motor and the command value of the target torque of the generator motor 19. When the first condition is not satisfied, the operation pattern switching unit 70 outputs a command for causing the generator motor 19 to operate as a power generator and the command value of the target torque of the generator motor 19.

As illustrated in FIG. 15, the internal combustion engine assisting unit 50 includes a control target value calculating unit 51, a generator motor output torque command value calculating unit 52, and a control enable flag generating unit 53. An output power command value Pei for the internal combustion engine 17, a revolution speed ng of the generator motor 19 (hereinafter, appropriately referred to as a generator motor revolution speed ng), and a torque Tr of the internal combustion engine 17 (hereinafter, appropriately referred to as an internal combustion engine torque Tr) are input to the internal combustion engine assisting unit 50. The output power command value Pei and the generator motor revolution speed ng are input to the control target value calculating unit 51, and the generator motor revolution speed ng and the internal combustion engine torque Tr are input to the control enable flag generating unit 53.

The generator motor output torque command value calculating unit 52 calculates a generator motor torque Tg which is the target torque value when the generator motor 19 is driven as an electric motor using the calculation result of the control target value calculating unit 51 and outputs the calculated generator motor torque. The control enable flag generating unit 53 generates a control enable flag Fp for enabling driving of the generator motor 19 as an electric motor using the calculation result of the control target value calculating unit 51, the generator motor revolution speed ng, and the internal combustion engine torque Tr.

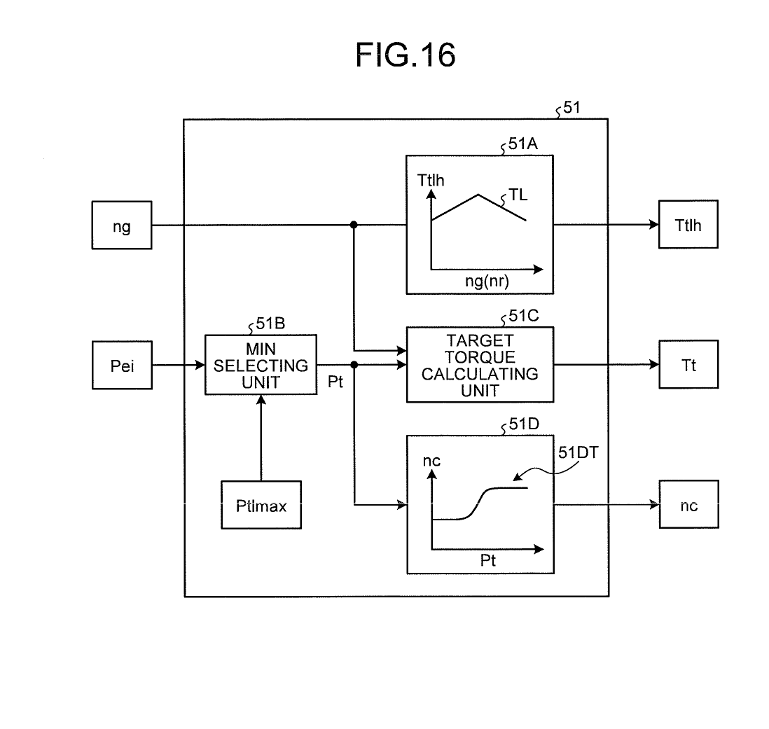

As illustrated in FIG. 16, the control target value calculating unit 51 includes a torque acquiring unit 51A, a minimum value selecting unit 51B, a target torque calculating unit 51C, and a control-determination revolution speed calculating unit 51D. The torque acquiring unit 51A substitutes the generator motor revolution speed ng, that is, the actual revolution speed nr of the internal combustion engine 17 for the maximum torque line TL and outputs the corresponding torque Ttlh. The torque acquiring unit 51A may acquire the actual torque t of the internal combustion engine 17.

The minimum value selecting unit 51B compares the output power command value Pei with the output power Ptlmax which is the maximum value Tmax in the maximum torque line TL and outputs the smaller output power as the output power command value Pt. This is to calculate the output power of the generator motor 19 so as to drive the generator motor 19 as an electric motor when the actual revolution speed nr of the internal combustion engine 17 illustrated in FIG. 5 is equal to or less than the revolution speed ntmax at the maximum value Tmax in the maximum torque line TL. As illustrated in FIG. 5, in the maximum torque line TL, the torque T decreases with the increase in the revolution speed n when the actual revolution speed nr of the internal combustion engine 17 is greater than the revolution speed ntmax at the maximum value Tmax in the maximum torque line TL. That is, in this range, the torque T increases with the decrease in the revolution speed n. Accordingly, even when the load LD is greater than the output power command value Pt, that is, the output instruction line ILt, the decrease in the revolution speed n is suppressed by the increase in the torque T due to the decrease in the revolution speed n. As a result, the possibility that the internal combustion engine 17 will stop decreases. Since the generator motor 19 is not unnecessarily driven as an electric motor by the processing of the minimum value selecting unit 51B, the opportunity that the internal combustion engine 17 drives the generator motor 19 to charge the electric power storage device 22. As a result, it is possible to suppress an increase in the amount of fuel consumed in the internal combustion engine 17.

The target torque calculating unit 51C calculates the torque Tt from the generator motor revolution speed ng, that is, the actual revolution speed nr of the internal combustion engine 17, and the output power command value Pt output from the minimum value selecting unit 51B and outputs the calculated torque as a target torque Tt. The target torque Tt can be calculated using Expression (1). The unit of the target torque Tt is N·m, the unit of the output power command value Pt is kw, and the unit of the generator motor revolution speed ng is rpm (revolution per minute).

Tt=Pt/ng×60×1000/(2×π) (1)

The control-determination revolution speed calculating unit 51D calculates the control-determination revolution speed nc illustrated in FIG. 6 from the output power command value Pt output from the minimum value selecting unit 51B. Since the control-determination revolution speed nc is a revolution speed at a position at which the output power command value Pt, that is, the output instruction line IL illustrated in FIG. 6, and the maximum torque line TL intersect each other, the control-determination revolution speed nc is uniquely determined from the output power command value Pt and the maximum torque line TL. The control-determination revolution speed calculating unit 51D includes a conversion table 51DT in which the relationship between the control-determination revolution speed nc and the output power command value Pt is described. The control-determination revolution speed calculating unit 51D calculates the control-determination revolution speed nc corresponding to the output power command value Pt output from the minimum value selecting unit 51B with reference to the conversion table 51DT and outputs the calculated control-determination revolution speed nc.

The generator motor output torque command value calculating unit 52 includes an adder and subtractor unit and a maximum value selecting unit. The adder and subtractor unit subtracts the torque Ttlh output from the target torque calculating unit 51C from the target torque Tt output from the target torque calculating unit 51C illustrated in FIG. 16 and outputs the resultant. The maximum value selecting unit compares the output of the adder and subtractor unit with 0 and outputs the larger value as the generator motor torque Tg.

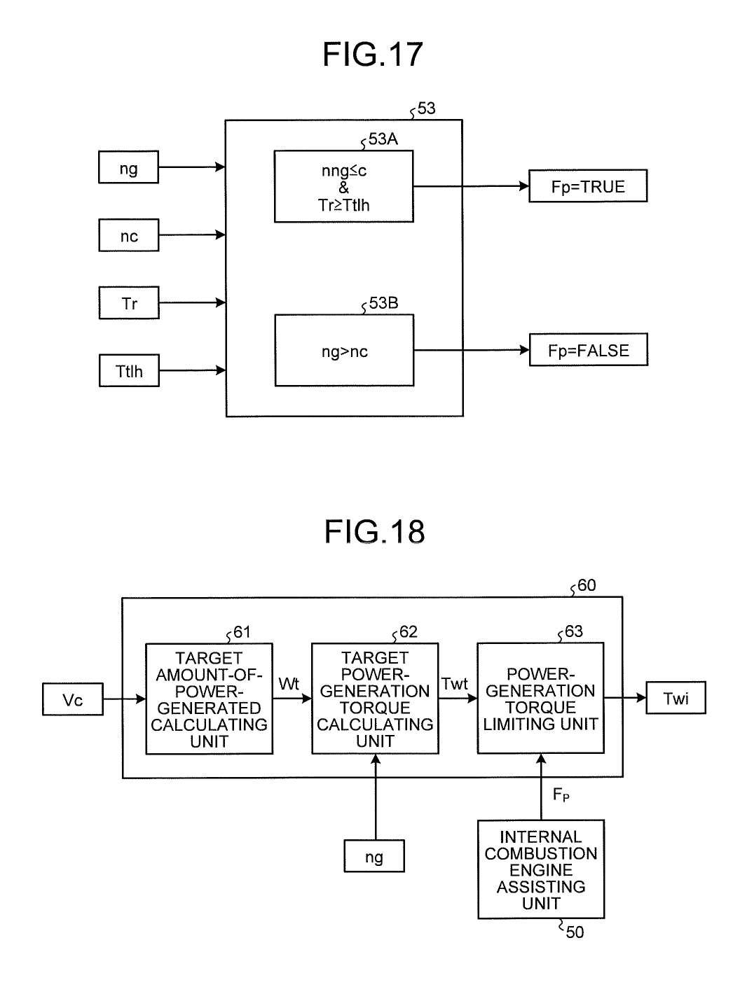

As illustrated in FIG. 17, the control enable flag generating unit 53 includes a control enable determining unit 53A and a control disable determining unit 53B. When the control enable flag Fp is TRUE, it is determined that the load LD is greater than the output power command value Pt and the generator motor 19 is allowed to be driven as an electric motor on the premise that the conditions of the actual revolution speed nr and the torque Tr of the internal combustion engine 17, that is, the first condition and the second condition, are satisfied. When the control enable flag Fp is FALSE, the generator motor 19 is not allowed to be driven as an electric motor. In this case, the generator motor 19 is driven as a power generator.

The generator motor revolution speed ng, the control-determination revolution speed nc, the internal combustion engine torque Tr, and the torque Ttlh are input to the control enable flag generating unit 53. The control enable determining unit 53A sets the control enable flag Fp to TRUE, when the generator motor revolution speed ng is equal to or less than the control-determination revolution speed nc and the internal combustion engine torque Tr is equal to or greater than the torque Ttlh. The control disable determining unit 53B sets the control enable flag Fp to FALSE, when the generator motor revolution speed ng is greater than the control-determination revolution speed nc. When the condition in which the generator motor revolution speed ng is equal to or less than the control-determination revolution speed nc and the condition in which the internal combustion engine torque Tr is equal to or greater than the torque Ttlh are not satisfied, the control enable determining unit 53A maintains the previous value of the control enable flag Fp. As described above, the control enable determining unit 53A may set to the control enable flag Fp to TRUE, when the generator motor revolution speed ng is equal to or less than the control-determination revolution speed nc and the internal combustion engine torque Tr is equal to or greater than the threshold value Ttll.

As illustrated in FIG. 18, the normal power generation processing unit 60 includes a target amount-of-power-generated calculating unit 61, a target power-generation torque calculating unit 62, and a power-generation torque limiting unit 63. The target amount-of-power-generated calculating unit 61 calculates a target amount of power generated Wt, which is a target value of the electric power which is generated by the generator motor 19, from a voltage Vc of the electric power storage device 22 (hereinafter, appropriately referred to as an electric power storage device voltage Vc) and outputs the target amount of power generated. The target power-generation torque calculating unit 62 calculates a target power-generation torque Twt, which is a target value of the torque for driving the generator motor 19 when the generator motor 19 generates electric power, from the target amount of power generated Wt and the generator motor revolution speed ng and outputs the calculated target power-generation torque. The target power-generation torque Twt is calculated using Expression (2). The target power-generation torque Twt is the driven torque Tggt described above. The unit of the target power-generation torque Twt is N·m, the unit of the target amount of power generated Wt is kw, and the unit of the generator motor revolution speed ng is rpm (revolution per minute).

Twt=Wt/ng×60×1000/(2×π) (2)

The power-generation torque limiting unit 63 adds modulation to the target power-generation torque Twt and outputs a command value Twi of the target power-generation torque Twt (hereinafter, appropriately referred to as a power-generation torque command value Twi). The power-generation torque command value Twi is the above-mentioned driven torque Tgg subjected to the modulation.

The target amount-of-power-generated calculating unit 61 includes an adder and subtractor unit, a gain applying unit, a minimum selecting unit. The adder and subtractor unit subtracts the input electric power storage device voltage Vc from a target electric power storage device voltage Vct. The target electric power storage device voltage Vct is a target value of the voltage across the electric power storage device 22 and is a fixed value. The gain applying unit applies a gain G to the output of the adder and subtractor unit and outputs the resultant. The gain G has a negative value. This is because when the generator motor 19 generates electric power, the output power and the torque of the generator motor 19 are expressed to be negative. The minimum value selecting unit compares the output of the gain apply unit with 0 and outputs the smaller value. The output of the gain applying unit has a negative value and is thus less than 0. The output of the minimum value selecting unit is the target amount of power generated Wt.

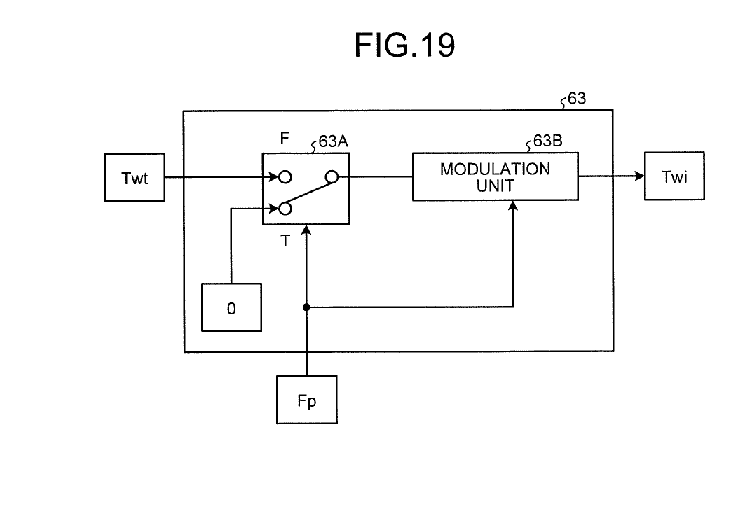

As illustrated in FIG. 19, the power-generation torque limiting unit 63 includes a switching unit 63A and a modulation unit 63B. The target power-generation torque Twt output from the target power-generation torque calculating unit 62 and 0 are input to the switching unit 63A. The switching unit 63A selects and outputs one input depending on the value of the control enable flag Fp. When the control enable flag Fp is FALSE, the switching unit 63A outputs the target power-generation torque Twt.

When the control enable flag Fp is TRUE, the generator motor 19 transitions from the state in which electric power is generated as a power generator to the state in which motive power is generated as an electric motor. At this time, when the target power-generation torque Twt is input to the modulation unit 63B, the target power-generation torque Twt is subjected to modulation, the power-generation torque command value Twi slowly decreases and becomes 0. When the generator motor 19 is driven as an electric motor, the power-generation torque command value Twi needs to rapidly become 0. Accordingly, when the control enable flag Fp is TRUE, the switching unit 63A outputs 0.

The modulation unit 63B performs modulation on the output of the switching unit 63A, and generates and outputs the power-generation torque command value Twi. As will be described later, the modulation unit 63B selects whether to output the output of the switching unit 63A without being subjected to the modulation or to output the output of the switching unit 63A subjected to the modulation depending on the value of the control enable flag Fp.

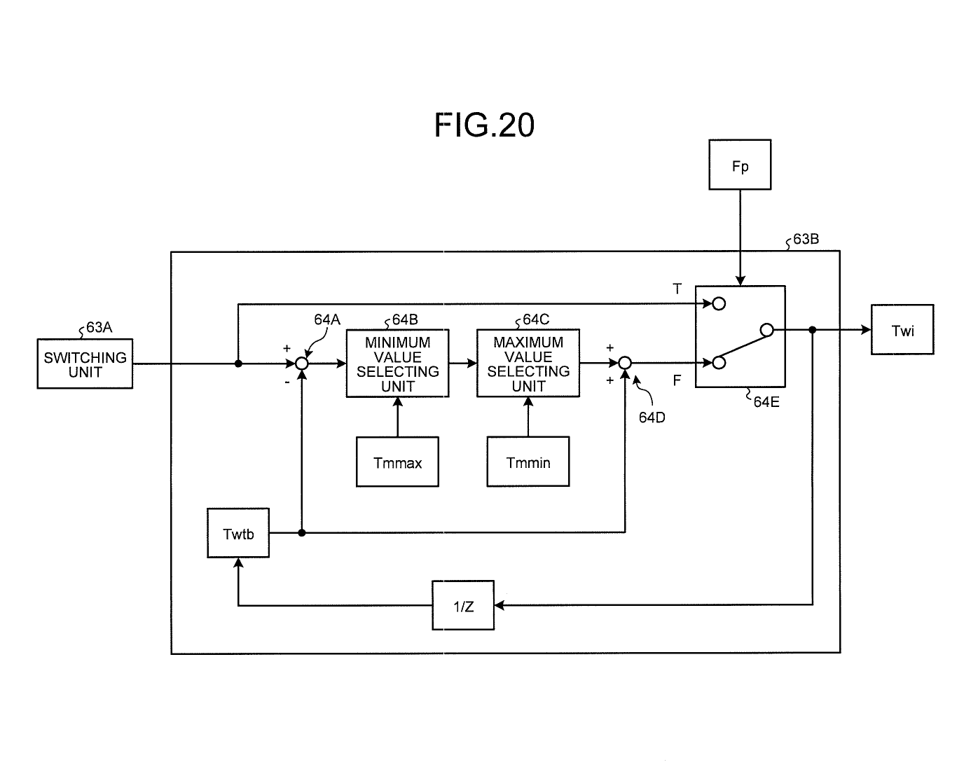

As illustrated in FIG. 20, the modulation unit 63B includes an adder and subtractor unit 64A, a minimum value selecting unit 64B, a maximum value selecting unit 64C, an adder and subtractor unit 64D, and a switching unit 64E. The adder and subtractor unit 64A subtracts a previous value Twtb of the target power-generation torque from the target power-generation torque Twt and outputs the resultant. The previous value Twtb will be described later.

The minimum value selecting unit 64B selects and outputs the smaller one of the output of the adder and subtractor unit 64A and an upper-limit modulation torque Tmmax. In this embodiment, the upper-limit modulation torque Tmmax is a limit value of the torque which can vary every control cycle of the hybrid controller 23. The maximum value selecting unit 64C selects and outputs the smaller one of the output of the minimum value selecting unit 64B and a lower-limit modulation torque Tmmin. The upper-limit modulation torque Tmmax is greater than the lower-limit modulation torque Tmmin. The adder and subtractor unit 64D adds the output of the maximum value selecting unit 64C to the previous value Twtb of the target power-generation torque and outputs the resultant.

The switching unit 64E selects and outputs one input depending on the value of the control enable flag Fp. When the control enable flag Fp is FALSE, the switching unit 64E outputs the calculation result of the adder and subtractor unit 64D. The output of the switching unit 63A is processed by the adder and subtractor unit 64A, the minimum value selecting unit 64B, the maximum value selecting unit 64C, and the adder and subtractor unit 64D, whereby the output of the switching unit 63A is subjected to the modulation. As a result, when the generator motor 19 transitions from the state in which electric power is generated as an electric motor to the state in which motive power is absorbed as a power generator, the power-generation torque command value Twi slowly varies from 0 in this embodiment to the target power-generation torque Twt. Accordingly, it is possible to suppress the hunting phenomenon in which the generator motor 19 is alternately driven as an electric motor and a power generator. When the control enable flag Fp is TRUE, the switching unit 64E outputs the target power-generation torque Twt without performing any process. The output of the switching unit 64E is the power-generation torque command value Twi.

A period of time after the target power-generation torque Twt is input to the modulation unit 63B until the modulation unit 63B outputs the power-generation torque command value Twi is defined as one control cycle of the hybrid controller 23. In this embodiment, the previous value of the output of the switching unit 64E, that is, the previous value Twtb of the target power-generation torque, in the storage unit of the hybrid controller 23. 1/Z in FIG. 20 means that the previous value Twtb of the target power-generation torque is stored in the storage unit of the hybrid controller 23. The previous value Twtb of the target power-generation torque is a value which is obtained in a control cycle immediately previous to the target power-generation torque Twt input to the modulation unit 63B.

<Engine Control Method According to Embodiment>

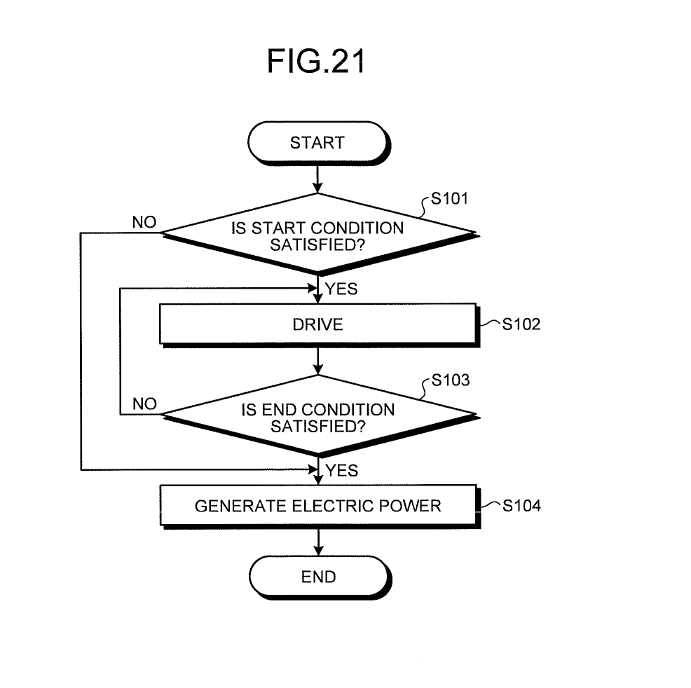

FIG. 21 is a flowchart illustrating an example of the engine control method according to this embodiment. In step S101, the hybrid controller 23 illustrated in FIG. 2 determines whether a start condition is satisfied. The start condition is a condition required for starting the process of causing the generator motor 19 to generate motive power on the premise that the load LD of the internal combustion engine 17 is greater than the output power command value Pei and the conditions of the actual revolution speed nr and the torque Tr of the internal combustion engine 17, that is, the first condition and the second condition, are satisfied. When the control enable flag Fp is TRUE, the generator motor 19 is allowed to be driven as an electric motor on the premise that the conditions of the actual revolution speed nr and the torque Tr of the internal combustion engine 17, that is, the first condition and the second condition, are satisfied and the load LD is greater than the output power command value Pt.

When the start condition is satisfied (step S101, Yes), the hybrid controller 23 drives the generator motor 19 as an electric motor in step S102. The process of driving the generator motor 19 as an electric motor is performed by the internal combustion engine assisting unit 50 illustrated in FIG. 14. In step S103, the hybrid controller 23 determines whether an end condition is satisfied. The end condition is a configuration required for causing the generator motor 19 to end generation of electric power and switching the generator motor to the process of generating electric power because the load LD of the internal combustion engine 17 is equal to or less than the output power command value Pei. The end condition is satisfied when the control enable flag Fp=FALSE is output from the control enable flag generating unit 53 illustrated in FIG. 17. That is, the end condition is satisfied when the generator motor revolution speed ng is greater than the control-determination revolution speed nc.

When the end condition is satisfied (step S103, Yes), in step S104, the hybrid controller 23 causes the generator motor 19 to operate as a power generator to generate electric power. When the end condition is not satisfied (step S103, No), the hybrid controller 23 repeats steps S102 and S103. When it is determined in step S101 that the start condition is satisfied (step S101, Yes), the hybrid controller 23 performs step S104.

In the engine control device and the engine control method according to this embodiment, when the load of the internal combustion engine 17 temporarily increases, the motive power generated from the generator motor 19, more specifically, the torque T, is increased by driving the generator motor 19 as an electric motor. By this process, it is possible to suppress stop of the internal combustion engine 17 when the load of the internal combustion engine 17 temporarily increases.

When a temporary increase in the load acting on the internal combustion engine 17 occurs, the torque T of the internal combustion engine 17 increases up to the maximum torque line TL and then the revolution speed n thereof decreases along the maximum torque line TL. Accordingly, when the matching route ML illustrated in FIGS. 4 and 5 and the like approaches the maximum torque line TL, an increasing region of the torque T when the temporary increase in the load acting on the internal combustion engine 17 decreases. As a result, the possibility that the revolution speed n of the internal combustion engine 17 greatly decreases or the internal combustion engine 17 stops rises.

In the engine control device and the engine control method according to this embodiment, when the load of the internal combustion engine 17 temporarily increases, the torque T generated from the generator motor 19 is increased as described above. Accordingly, it is possible to suppress a great decrease in the revolution speed n of the internal combustion engine 17 and the stop of the internal combustion engine 17. Therefore, in the engine control device and the engine control method according to this embodiment, it is possible to cause the matching route ML to approach the maximum torque line TL. As a result, since the internal combustion engine 17 is driven at a lower revolution speed n with the same output power, the frictional loss is reduced and the amount of fuel consumed is suppressed.

When the generator motor 19 is driven as an electric motor, the actual revolution speed nr of the internal combustion engine 17 can be controlled to reach a target revolution speed. In this case, for the purpose of avoiding a hunting phenomenon, the generator motor 19 is not driven as an electric motor when the difference between the actual revolution speed nr and the target revolution speed reaches a certain magnitude. Accordingly, when the load of the internal combustion engine 17 temporarily increases, there is a possibility that the decrease in the revolution speed n of the internal combustion engine 17 will not be suppressed by the control delay when the actual revolution speed nr of the internal combustion engine 17 is controlled to reach the target revolution speed.

When the magnitude of the torque to be generated is instructed, the generator motor 19 generates a torque with the instructed magnitude without almost any delay. In the engine control device and the engine control method according to the above-mentioned embodiment, when the load of the internal combustion engine 17 temporarily increases, the torque T increases using the command for increasing the torque T of the generator motor 19. Since the delay of control hardly occurs by this process, it is possible to more satisfactorily suppress stop of the internal combustion engine 17.

In the above-mentioned embodiment, the excavator 1 including the internal combustion engine 17 is described as an example of the work machine, but the work machine to which the embodiment can be applied is not limited to the excavator. For example, the work machine may be a wheel loader, a bulldozer, or a dump truck. The type of the engine mounted on the work machine is not particularly limited.

While the embodiment has been described above, the embodiment is not limited to the above-described details. The above-mentioned elements include elements which can be easily thought out by those skilled in the art, elements which are substantially equal thereto, or elements within an equivalent range. The above-mentioned elements may be appropriately combined. The elements can be omitted, substituted, or modified in various forms without departing from the gist of the embodiment.

### REFERENCE SIGNS LIST

1 EXCAVATOR
1PS DRIVE SYSTEM
2 VEHICLE BODY
3 WORKING IMPLEMENT
17 INTERNAL COMBUSTION ENGINE
17n REVOLUTION SPEED SENSOR
18 HYDRAULIC PUMP
19 GENERATOR MOTOR
19I GENERATOR MOTOR CONTROL DEVICE
22 ELECTRIC POWER STORAGE DEVICE
23 HYBRID CONTROLLER
23M STORAGE UNIT
23P PROCESSING UNIT
23IO INPUT AND OUTPUT UNIT
28 FUEL ADJUSTMENT DIAL (THROTTLE DIAL)
30 ENGINE CONTROLLER
33 PUMP CONTROLLER
35 IN-VEHICLE LAN
36 ENGINE
50 INTERNAL COMBUSTION ENGINE ASSISTING UNIT
51 CONTROL TARGET VALUE CALCULATING UNIT
51A TORQUE ACQUIRING UNIT
51B MINIMUM VALUE SELECTING UNIT
51C TARGET TORQUE CALCULATING UNIT
51D CONTROL-DETERMINATION REVOLUTION SPEED CALCULATING UNIT
51DT CONVERSION TABLE
52 GENERATOR MOTOR OUTPUT TORQUE COMMAND VALUE CALCULATING UNIT
52A ADDER AND SUBTRACTOR UNIT
52B MAXIMUM VALUE SELECTING UNIT
53 CONTROL ENABLE FLAG GENERATING UNIT
53A CONTROL ENABLE DETERMINING UNIT
53B CONTROL DISABLE DETERMINING UNIT
60 NORMAL POWER GENERATION PROCESSING UNIT
61 TARGET AMOUNT-OF-POWER-GENERATED CALCULATING UNIT
61A ADDER AND SUBTRACTOR UNIT
61B GAIN APPLICATION UNIT
61C MINIMUM VALUE SELECTING UNIT
62 TARGET POWER-GENERATION TORQUE CALCULATING UNIT
63 POWER-GENERATION TORQUE LIMITING UNIT
63A SWITCHING UNIT
63B MODULATION UNIT
64A, 64D ADDER AND SUBTRACTOR UNIT
64B MINIMUM VALUE SELECTING UNIT
64C MAXIMUM VALUE SELECTING UNIT
64C MAXIMUM VALUE SELECTING UNIT
64E SWITCHING UNIT
64C SELECTION UNIT
70 OPERATION PATTERN SWITCHING UNIT
IL OUTPUT INSTRUCTION LINE
LD LOAD
ML MATCHING ROUTE
PL PUMP ABSORPTION TORQUE LINE
TL MAXIMUM TORQUE LINE
TP MATCHING POINT

1. An engine control device of a hybrid work machine comprising, in controlling an internal combustion engine which is an engine generating motive power and of which an output shaft used to extract the generated motive power is connected to a generator motor,
causing the generator motor to generate motive power when both of a first condition which is satisfied or not satisfied based on a result of comparison of an actual revolution speed of the internal combustion engine with a revolution speed acquired from a first relationship and a second relationship and a second condition which is satisfied or not satisfied based on a result of comparison of a torque of the internal combustion engine at the actual revolution speed with a torque acquired using the first relationship at the actual revolution speed are satisfied,
wherein the first relationship is a relationship between a revolution speed of the internal combustion engine and a torque which is able to be generated by the internal combustion engine at the revolution speed, and
wherein the second relationship is a relationship between the torque and the revolution speed of the internal combustion engine which is used to define a magnitude of the motive power generated from the internal combustion engine.

2. The engine control device of a hybrid work machine according to claim 1, wherein the first condition is satisfied when the actual revolution speed of the internal combustion engine is equal to or lower than the revolution speed acquired from the first relationship and the second relationship, and
wherein the second condition is satisfied when the torque of the internal combustion engine at the actual revolution speed is equal to or greater than a value which is smaller by a predetermined magnitude than the torque acquired from the first relationship at the actual revolution speed.

3. The engine control device of a hybrid work machine according to claim 2, wherein the engine control device determines the torque which is generated by the generator motor based on the torque acquired from the second relationship at the actual revolution speed and the torque acquired from the first relationship at the actual revolution speed.

4. The engine control device of a hybrid work machine according to claim 1, wherein the engine control device increases a command value for causing the generator motor to generate electric power from a value smaller than a target value of the command value with a lapse of time when the engine control device switches from a state in which the generator motor generates motive power to a state in which the generator motor generates electric power.

5. The engine control device of a hybrid work machine according to claim 1, wherein the engine control device causes the generator motor to generate motive power when the actual revolution speed of the internal combustion engine is equal to or lower than a revolution speed corresponding to a maximum torque of the first relationship.

6. A hybrid work machine comprising:
the engine control device of a hybrid work machine according to claim 1;
the internal combustion engine;
the generator motor that is driven by the internal combustion engine; and
an electric power storage device that stores the electric power generated by the generator motor.

7. An engine control method of a hybrid work machine comprising, in controlling an internal combustion engine which is an engine generating motive power and of which an output shaft used to extract the generated motive power is connected to a generator motor,
determining whether to satisfy a first condition which is satisfied or not satisfied based on a result of comparison of an actual revolution speed of the internal combustion engine with a revolution speed acquired from a first relationship and a second relationship and a second condition which is satisfied or not satisfied based on a result of comparison of a torque of the internal combustion engine at the actual revolution speed with a torque acquired using the first relationship at the actual revolution speed; and
outputting a drive command for driving the generator motor when both the first condition and the second condition are satisfied,
wherein the first relationship is a relationship between the revolution speed of the internal combustion engine and the torque which is able to be generated by the internal combustion engine at the revolution speed, and
wherein the second relationship is a relationship between the torque and the revolution speed of the internal combustion engine which is used to define a magnitude of the motive power generated from the internal combustion engine.

8. The engine control method of a hybrid work machine according to claim 7, wherein the first condition is satisfied when the actual revolution speed of the internal combustion engine is equal to or lower than the revolution speed acquired from the first relationship as a relationship between the revolution speed of the internal combustion engine and the torque which is able to be generated by the internal combustion engine at the revolution speed and the second relationship as a relationship between the torque and the revolution speed of the internal combustion engine which is used to define the magnitude of the motive power generated from the internal combustion engine, and
wherein the second condition is satisfied when the torque of the internal combustion engine at the actual revolution speed is equal to or greater than a value which is smaller by a predetermined magnitude than the torque acquired from the first relationship at the actual revolution speed.
